(19) United States
(12) Patent Application Publication
(10) Pub. No.: US 2026/0288335 A1
(43) Pub. Date: Sep. 24, 2026

(54) LOCALIZATION OF VERTEX ATTRIBUTES, CONSTANTS AND LOCAL MEMORY IN A MULTI-CHIP GPU

(71) Applicant: NVIDIA Corporation, Santa Clara, CA (US)

(72) Inventors: Ziyad HAKURA, Santa Clara, CA (US); Karim ABDALLA, Santa Clara, CA (US); Andrei KHODAKOVSKY, Santa Clara, CA (US); Eric WERNESS, Santa Clara, CA (US)

(21) Appl. No.: 19/087,436

(22) Filed: Mar. 21, 2025

(51) Int. Cl. G06F 3/06; G06F 12/0815

(52) U.S. Cl. CPC G06F 3/0611; G06F 3/0656; G06F 3/0659; G06F 3/0673; G06F 12/0815

(57) ABSTRACT

Methods and systems are described for localizing writes of certain graphics pipeline attributes, localizing certain page pool and root table version buffers, and/or localizing of local memory in order to improve the latency of write operations and/or to reduce the inter-chip traffic in a multi-chip graphics processing unit (GPU) that uses a common unified memory. The described localizing may be implemented over a coarse-grained interleaving of the virtual memory on the locally connected memories of each GPU in the multi-chip GPU.

### CROSS-REFERENCE TO RELATED APPLICATIONS

None.

### FIELD

The technology herein relates to graphics processing units (GPUs) and to memory access techniques within multiple GPU die systems. More particularly, the technology herein relates to a multiple GPU die based system of the type that uses unified memory addressing to enable multiple GPUs to have a common unified view into memory and access each other's locally connected memory.

### BACKGROUND & SUMMARY

Modern high performance computing systems provide high degrees of parallel execution in both a multi-core central processing unit (CPU) and in one or more graphics processing units (GPUs) the CPU supervises and controls.

GPU hardware subsets—which are sometimes called “Graphics Processing Clusters” or GPCs—comprise the dominant high-level hardware block of many GPUs. In some designs, each GPC includes dedicated pipelined graphics rendering hardware, plus a number of “streaming multiprocessors” (“SMs”). or other software-programmable processing cores capable of executing shader software. The graphics pipelined rendering hardware of each GPC may comprise one or more Primitive Engines and one or more Raster Engines. Each Primitive Engine is responsible for handling Vertex Fetch, Tessellation, Viewport Transform, Attribute Setup, and Stream Output, and supports out of order execution to provide parallelism and hide memory system latency. Each Raster Engine does edge/triangle setup, rasterization, and z-culling in a pipelined manner and provides plural raster operation partitions (“ROPs”) (each partition containing a number of ROP units). Primitive Engine(s) and Raster Engine(s) collectively accelerate operation-intensive rendering processes such as polygon shading, level of detail control, texture mapping, hidden surface removal/alpha transparency processing, rasterization, tessellation, etc. under control of one or more programmable software shaders executing on the SMs. Each SM in turn may contain many processing cores, some number of Tensor Cores, a Register File, some number of Texture Units, a Ray Tracing Core, and L1/Shared Memory which can be configured with differently sized sub-partitions, depending on the needs of the compute or graphics workloads. Each GPC also needs to be able to access memory so it can store and retrieve data needed for its tasks. Such GPCs are the basic functional processing building blocks of the GPU.

More and more GPCs can be packed into the same GPU to increase parallelism—but providing each GPC with high speed memory access can become increasingly challenging. As graphics processing units (GPUs) scale, a fully connected “crossbar” (xbar) between each GPC and the memory subsystem would be too costly to build. NVIDIA has instead structured some GPUs so that multiple GPCs form a “micro GPU” (uGPU). Each uGPU comprises GPCs and on-chip “L2” (level 2) cache memory connected together using a fully connected crossbar. These internally fully connected uGPU clusters are then connected together using L2 network-on-chip (“NOC”) or chip-to-chip (“C2C”) connections to form a big GPU that is referred to in this disclosure as a “multiple GPU chip GPU” or a “multi-chip GPU”. See FIGS. 1 & 1A and e.g., U.S. Pat. No. 10,915,445.

FIG. 2 shows a number of frame buffer partitions connected across different GPCs. The screen is subdivided across GPCs based on a screen mapping. Each GPC operates on their own assigned portions of the framebuffer. In this example, no single GPC has to render the entire frame buffer; instead, they work together in a coordinated fashion to “divide and conquer”. Specifically, the frame buffer is cut up checkerboard style into a number of different areas called “tiles”, and each GPC's Raster Engine is assigned a different set of one or more tiles for rendering into. For each render target configuration, graphics objects are first processed in a world space pipeline. The world space pipeline creates graphics primitives associated with the graphics objects. The world space pipeline provides the graphics primitives to all Raster Engines responsible for rendering into their respective tiles. For each primitive coming into a GPC, the GPC stores the primitive into some number of per-tile bins (e.g., buffers), corresponding to the tiles that the primitive intersects with, and where a tile represents a distinct portion of the screen surface designated to that GPC only. After the primitives are sorted into bins, for each tile, all the graphics primitives for a tile are then processed by the GPC's screen space pipeline that is temporarily configured to render only the pixels of that particular screen tile before moving on. See e.g., U.S. Pat. No. 8,704,826, the entire disclosure of which is herein incorporated by reference. In this way, each GPC hardware unit is able to render into its own subset of tiles of the frame buffer-much like a number of quilters can fashion different quilt squares independently and then all their squares are stitched together into a single large quilt.

The GPCs rendering different tiles are able to communicate via the system's unified memory architecture. In the FIG. 2 example, each uGPU comprises a number (e.g., four) GPCs connected by a memory management unit (MMU) to a “crossbar”. The GPCs use the crossbar to access stacks of high bandwidth memory (“HBM”) comprising dynamic random access memory (DRAM) chips forming the GPU's memory subsystem backed by an on-chip cache (e.g., L2). See e.g., U.S. Pat. No. 11,663,036. The crossbars also provide a high speed communications interface that permits the uGPUs to communicate with one another. The crossbars provide a communications path between each uGPU and an “NVLINK” NOC communications interface that enables the GPU to communicate with other GPUs that in turn are composed of uGPUs comprising GPCs. Such crossbars are for example able to communicate information produced by the world space pipelines of each uGPU to the screen space pipelines of any uGPU. Thus, each uGPU is able to communicate with any other uGPU in the system and each GPC is able to access the memory of any other GPC—offering tremendous flexibility in terms of parallelism, processing coordination and data sharing. Such flexibility is consistent with the unified virtual addressing shown in FIG. 3. See e.g., CUDA Programming Guide v12.1 Section 19 (“Unified Memory Programming”)

While the above arrangement has worked well for a number of years, there is now a need to increase the complexity of a single GPU beyond what can fit on a single reticle used to manufacture the semiconductor dies that make up integrated circuit chips. This means that the single GPU can now span across multiple semiconductor dies, with coordination and communications between the dies to allow the multiple dies to operate as a unified multi-chip GPU. See, e.g., U.S. application Ser. No. 18/606,924.

For purposes of description below, and without limitation, an example multi-chip GPU with two dice, each with one uGPU fabricated on it will be used. Because on-chip communications are generally faster than communications between chips, each uGPU in the multi-chip GPU in the example can access (e.g., for a write operation) its own locally connected memory, which is on-chip, faster than the locally connected memory of another uGPU in the multi-chip GPU that is reached via a chip-to-chip (C2C) communication link between the uGPUs on different dies. In multi-chip GPUs that use a common unified memory, data generated on a uGPU may often be written to the locally connected memory of another uGPU via the C2C link or other inter-uGPU link, thereby incurring high latencies in competing write operations etc.

Such inter-chip latencies can slow things down when the multi-chip GPU's multiple graphics pipelines (which are now situated on different dies) work together to render the same image. There may be hundreds or thousands of calculations needed to render the tile. Using conventional acknowledge-based messaging to share just the results of such calculations between the dies can slow down what otherwise would be extremely fast parallel processes.

Methods and systems for improving the performance of multi-chip GPU systems by reducing the latency of data accesses are still desired.

### BRIEF DESCRIPTION OF THE DRAWINGS

FIGS. 1 & 1A are block diagrams of a prior art GPU architecture providing inter-GPU communications.

FIG. 2 is a block diagram of a prior art GPU architecture.

FIG. 3 is a block diagram showing prior art unified virtual addressing within a processing system including multiple GPUs.

FIG. 4 is a block diagram of an example multi-chip GPU architecture according to some embodiments.

FIG. 5A and FIG. 5B show two alternative allocations of a common unified memory in a two-chip GPU such as that shown in FIG. 4, with localization mode, according to some embodiments.

FIG. 6A shows an example graphics pipeline according to some embodiments.

FIG. 6B shows example alpha and beta circular buffers in the world-pipe portion of the graphics pipeline are cached in L2 and allocated in video memory (e.g. framebuffer memory), according to some embodiments.

FIG. 7 shows example alpha and beta circular buffers allocated in framebuffer memory of uGPUs and are typically cached in the L2 of each uGPU, according to some embodiments.

FIG. 8 shows how to localize circular buffers through the use of padding and alignment to 2 MB pages where necessary, according to some embodiments.

FIG. 9 illustrates a circular buffer FIFO with circular buffer entries (CBEs), according to some embodiments.

FIG. 10 illustrates what it means for the page pool and root table version circular buffers to be localized, according to some embodiments.

FIG. 11 illustrates a manner of localizing the page pool and root table version circular buffers, according to some embodiments.

FIG. 12 illustrates a two die GPU with local memory associated with the data processing clusters (DPCs) of each die allocated in the physical memory of the framebuffer (FB) that is directly attached to the same die, according to some embodiments.

FIG. 13 illustrates a manner of localizing the local memory in the GPU shown in FIG. 12, according to some embodiments.

FIG. 14 illustrates an example parallel processing unit of a GPU, according to some embodiments.

FIG. 15A illustrates an example general processing cluster (GPC) within the parallel processing unit of FIG. 8, according to some embodiments.

FIG. 15B illustrates an example memory partition unit of the parallel processing unit of FIG. 14.

FIG. 16A illustrates an example streaming multiprocessor (SM) of FIG. 15A with MMA state machine circuitry, according to some embodiments.

FIG. 16B conceptually illustrates four subpartitions implemented in an SM such as the SM shown in FIG. 16A, according to some embodiments.

FIG. 17A is an example conceptual diagram of a processing system implemented using the parallel processing unit (PPU) of FIG. 14.

FIG. 17B is a block diagram of an exemplary system in which the various architecture and/or functionality of the various previous embodiments may be implemented.

### DETAILED DESCRIPTION OF NON-LIMITING EMBODIMENTS

When a GPU's graphics rendering hardware is distributed across multiple dies, it turns out that only some (not all) of the data written to memory needs to be communicated across the multiple dies. Example solutions herein accordingly localize certain data writes in graphics workloads and/or the graphics render pipeline (e.g., page pool and root table version (RTV) buffers, constants, local graphics memory of the SM, vertex buffers, ray sorting for ray tracing, etc.) into a locally connected memory (e.g., video memory) that hardware on another die can access e.g., via a coherent caching mechanism.

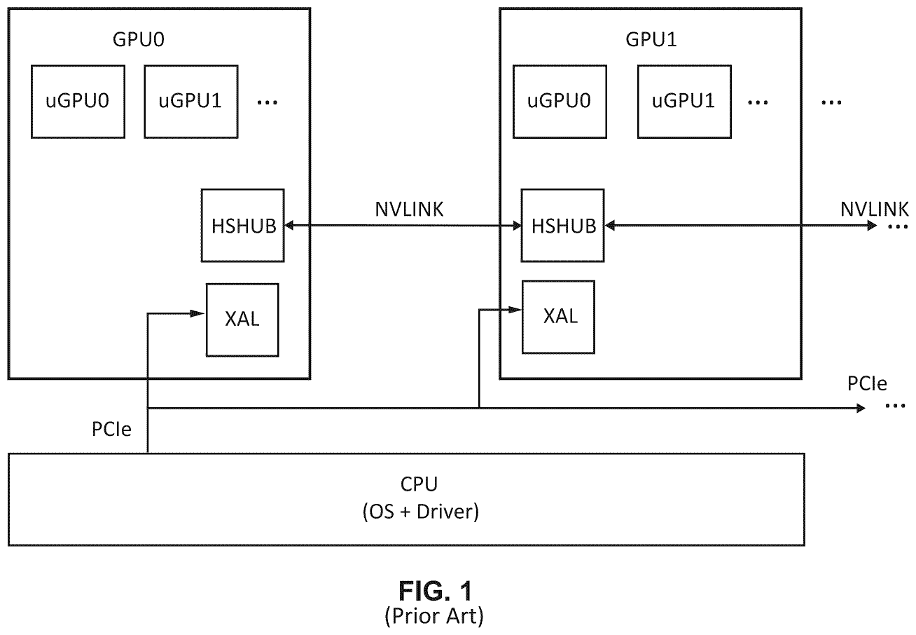

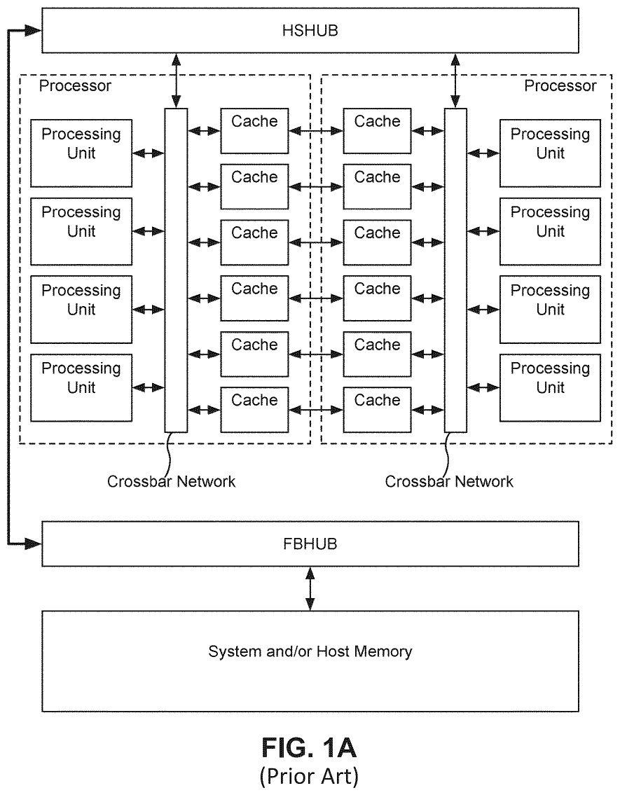

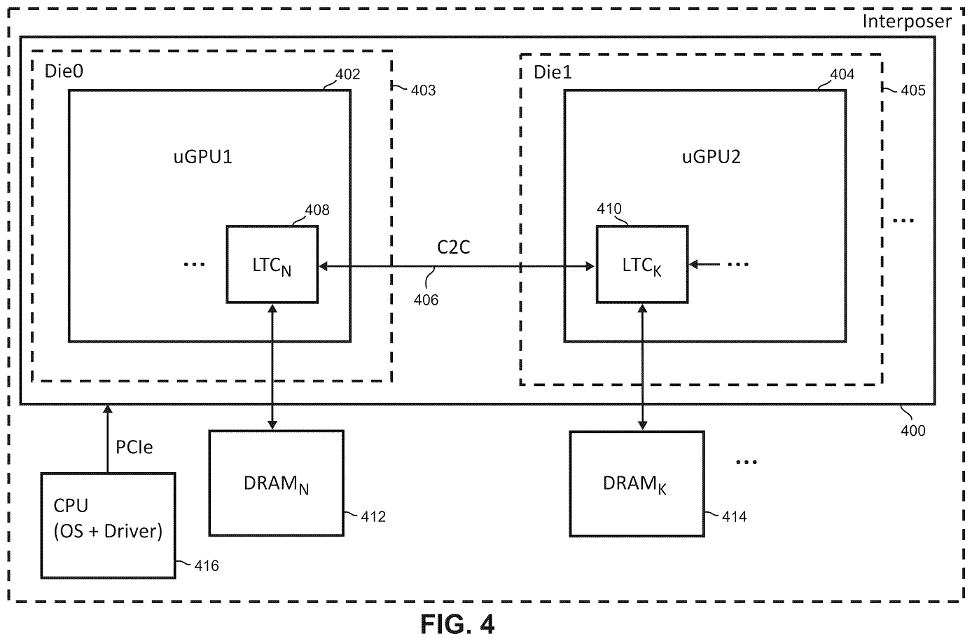

The term “multi-chip GPU,” as used in this disclosure, may refer to a single GPU that has two or more uGPUs each on a separate die, as shown in FIG. 4, or a system that has two or more GPUs each of which may or may not have one or more uGPUs. FIG. 1 illustrates a system with two GPUs (GPU0 and GPU1) each of which has a plurality of uGPUs (uGPU0, uGPU1, . . . ). However, as noted above and without limitation, for purposes of the description below an example two-chip GPU with one uGPU on each die is used.

As noted above, data accesses (e.g., write/read operations) in a multi-chip GPU can experience substantial latency when one uGPU accesses the memory of another uGPU. In a multi-chip GPU that has a common unified memory, the same virtual address space is accessible to all uGPUs and is distributed over the locally-connected memory subsystems (e.g., physical memory, DRAM, backed by an on-chip cache) of each of the uGPUs. Each uGPU writes to the virtual address space, and, in accordance with the common unified memory, the written data may be stored in the locally connected physical memory of another uGPU. The technology disclosed in this disclosure solves problems relating to the latency of certain operations (e.g., read operations and write operations) that cause one uGPU to access the locally connected memory of another uGPU. Some example solutions provide one or more of localization of writes of certain data in the graphics pipeline and more generally graphics workloads, localization of page pool and root table version (RTV) buffers, localization of constants, localization of local memory of each SM, and/or localization of ray sorting. Example solutions provide new functionality in both hardware and software.

Each of the disclosed localizations noted above improves the performance of the example multi-chip GPU by reducing the inter-uGPU traffic and/or by reducing the latency of selected read operations and write operations. The multi-chip GPU may implement one or any combination of the localizations in this disclosure.

### Localized Vertex Attributes

In some embodiments, each uGPU in the multi-chip GPU is configured to write vertex attributes that are generated by one stage of the graphics processing pipeline to a next or another stage via circular buffers in the locally connected memory of that same uGPU. For example, these embodiments may provide for the localization of such circular buffer attributes (e.g., vertex attributes) passed between the world-pipe, such as vertex shaders, and screen pipe pixel shaders, or for passing attributes between amplification shaders and mesh shaders (e.g., in Direct3D environments). In this context, the circular buffer entries (CBEs) are allocated on the same die as the Primitive Engine (PE) units that write to memory based on those attributes. This results in reduced write acknowledge latency, reduced need for latency hiding FIFOs, and reduced consumption of the bandwidth between dies as write traffic for CBEs is often higher bandwidth than read traffic (e.g., due to culling in the screen pipeline).

### Localized Graphics Constants

In some embodiments, localization of constants, in particular page pool and root table version (RTV) circular buffers, are provided. In this context, the page pool and RTV circular buffers are allocated on the same die as where the shader cache controller (SCC) unit in the front pipe resides. This results in reduced write acknowledge latency. Reducing latency in the front of the pipe is particularly important because the front pipe is often a bottleneck in modern GPU workloads.

### Localized Local Graphics Memory of Each SM

In some embodiments, localization of local memory of each SM (“SM local memory) is provided. Each warp, whether a compute warp or a graphics shader warp, running on an SM can access SM local memory, which is a global memory pool dedicated for the warp and whose contents are only used as a buffer during the execution of the warp. By allocating SM local memory on the same die as the SM that accesses that memory, the unnecessary write traffic across dies (e.g. L2 cache on a die may be write through to the POC (Point of Coherence) L2 cache) is avoided. If the SM local memory is not localized, then this write through traffic would cross one die to another to reach the POC L2. The POC L2 cache for a write operation is the L2 cache for which the backing memory is the locally connected memory on the same die as the L2 cache. Moreover, localized SM local memory also provides for reads to have lower latency since the POC L2 cache for those reads would reside on the same die.

Each of these localizations may be implemented on a coarse grain (e.g., 32 MB) interleaving of memory across dies of the multi-chip GPU. For the localization of vertex attributes and for the localization of the page pool and RTV circular buffers, the data that is localized may still be accessed by any DPC in the entire multi-chip GPU, including those on remote dies.

### Example Overall Hardware Architecture

One example GPU chip implementation is built upon the concept of the uGPU described above to tackle the area concerns with a large chip using a single central xbar. As FIG. 4 shows, the GPU 400 is divided into plural (e.g., two) sub-groups (uGPUs). A central xbar is within each uGPU and the plural uGPUs are connected using point-to-point C2C 406 through LTC slice pairs (L2 caches) 408 and 410. In one embodiment, the two uGPUs 402 and 404 are fabricated on different dies 403 and 405. The multi-chip GPU 400 may be disposed on an interposer along with locally connected DRAM memory (e.g., High Bandwidth Memory (HBM) 3D-stacked synchronous dynamic random-access memory (SDRAM), Graphics double data rate (GDDR) SDRAM) 412 and 414 of the uGPUs 408 and 410, and, in some embodiments, a CPU 416. See for example U.S. Pat. No. 11,609,879. The interposer is disposed within a package that is in turn mounted and connected to a printed circuit board. There is extra latency to go across the C2C when a GPC in one uGPU has to access data stored in the other uGPU. The C2C bandwidth and duplication of data in the LTCs (hence reduction of the useful cache capacity) will also impact the overall performance of applications.

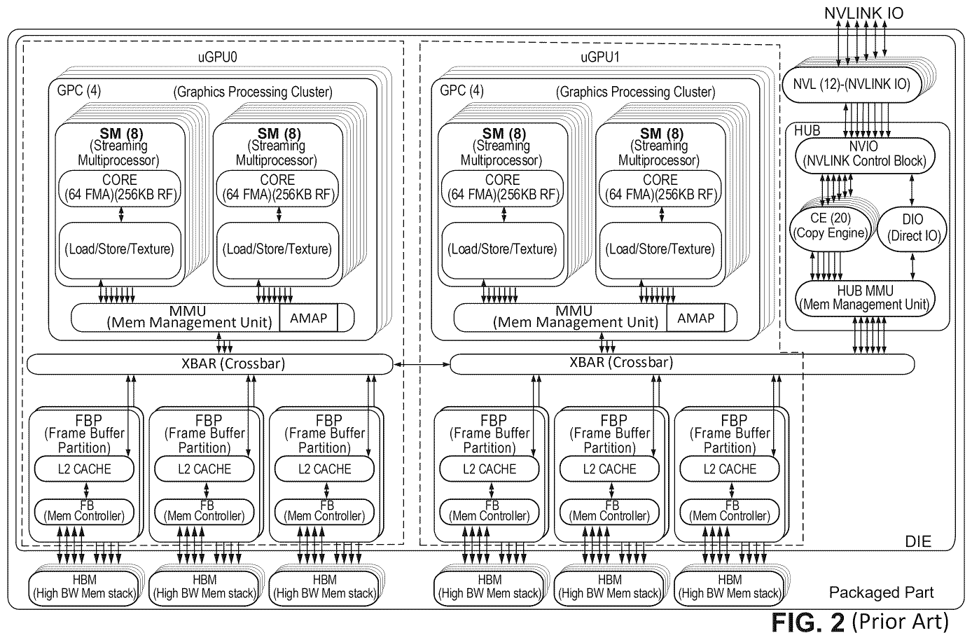

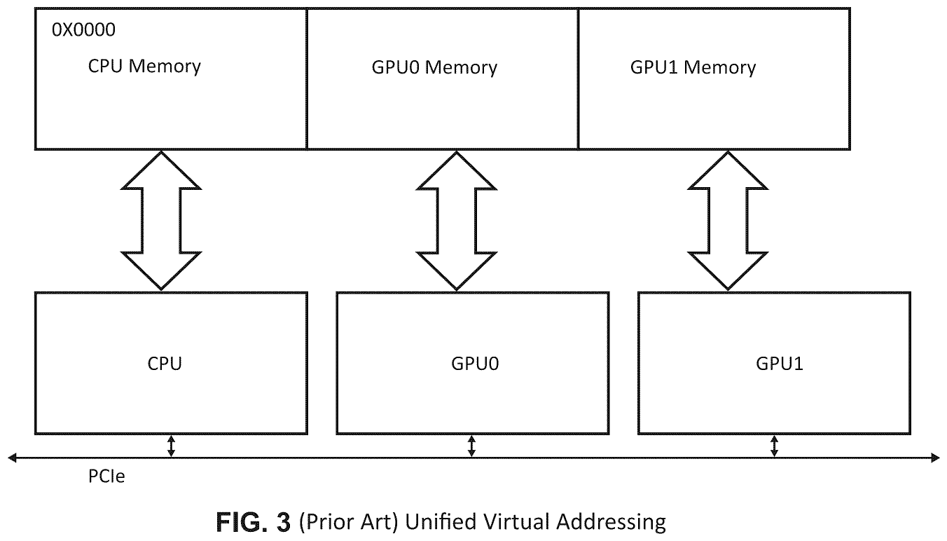

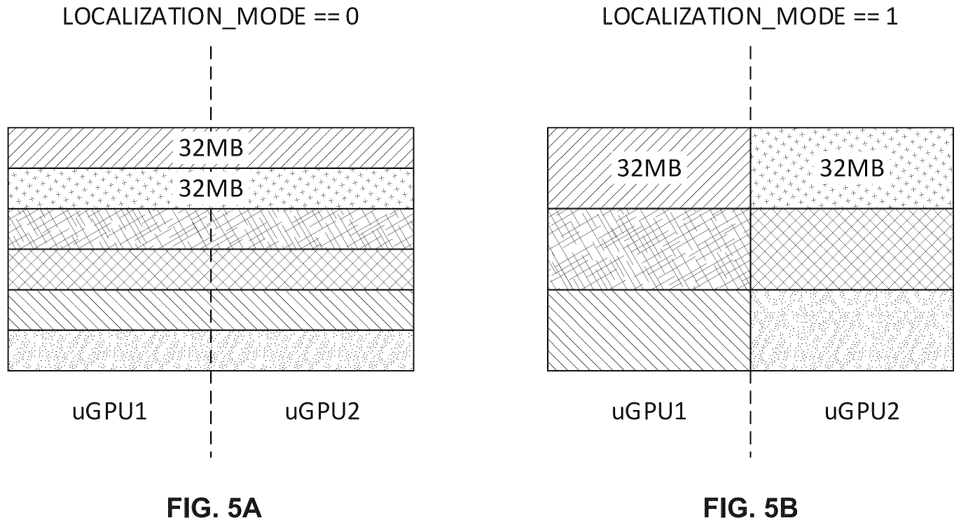

U.S. application Ser. No. 18/239,733 describes an alternative for an application to choose between a fully interleaved unified view of memory, as described in U.S. Pat. No. 11,893,653, or localized view per uGPU. An address mapping (AMAP) unit (hardware) provides an additional localized mapping to the uGPU so application data can be localized to a specific uGPU (see FIG. 2 and FIGS. 21-23 of U.S. Pat. No. 11,249,905 and associated description for more information on example MMU AMAPs). The AMAP may be configured to provide two alternative views for the same addressable space of the locally connected memory of a uGPU. One view (the traditional view) is a stride view which maps all addresses into all memory units or devices across the full GPU address space (see FIG. 3). In this traditional view of memory, linearly increasing the memory address will stride across all of the DRAMs of the GPU memory system, thereby (evenly) distributing data across all of the individual DRAMs making up the memory for the overall GPU. See e.g., U.S. Pat. No. 11,182,309; US20130031328; U.S. Pat. No. 11,249,905. The other view is a localized view which divides or partitions a unit memory space (e.g., 64 MB) into individual plural address spaces associated with the respective plural uGPUs in such a way that, in a two uGPU GPU, the first memory block (e.g., 32 MB) allocation will always go to uGPU1, the second memory block (e.g., 32 MB) allocation will always go to uGPU2, and so on, as shown in FIG. 5B and described in more detail below.

In an example, when the address mapping hardware is doing an address translation, it looks at an address mode bit. If it is 0 (or is not set), normal stride mapping is applied (see FIG. 5A). The hardware will fine interleave every memory block across the full GPU memory system at a predetermined uGPU stride. When the mode bit is 1, the hardware in one embodiment maps the first block of aligned addresses to uGPU1 and the later (second) block of the aligned addresses to uGPU2. FIG. 5B shows how the addresses are distributed according to the mode bit value. As FIG. 5B shows, in one embodiment, when the mode bit is set, a coarse interleaving is performed with all the even first (32 MB in this example) block chunks being (re)mapped by hardware to uGPU1 and all the odd second (32 MB) block chunks will be (re)mapped by hardware to uGPU2. Software will be able to look at the physical memory allocation to determine which memory block to access. In some embodiments, any one or more of the disclosed localizations may be implemented on a coarse grain (e.g., 32 MB) interleaving of memory across dies of the multi-chip GPU as shown in FIG. 5B.

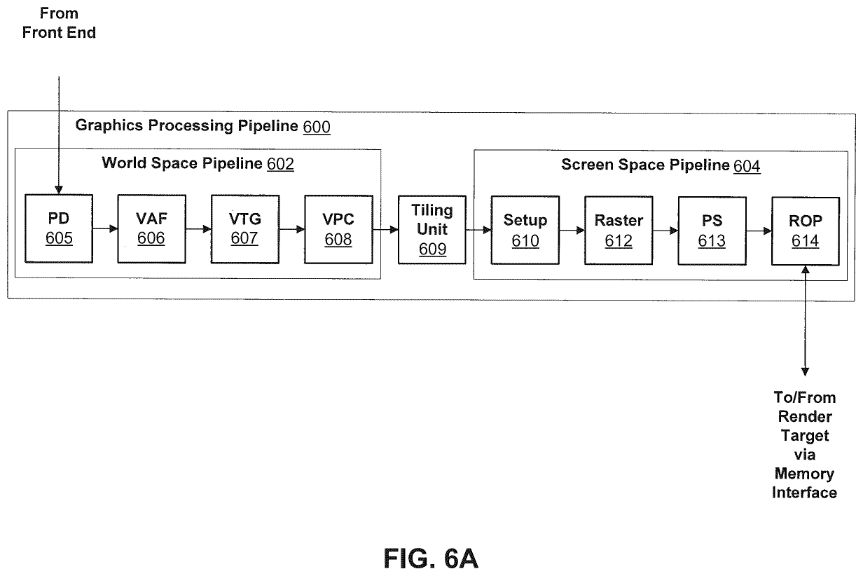

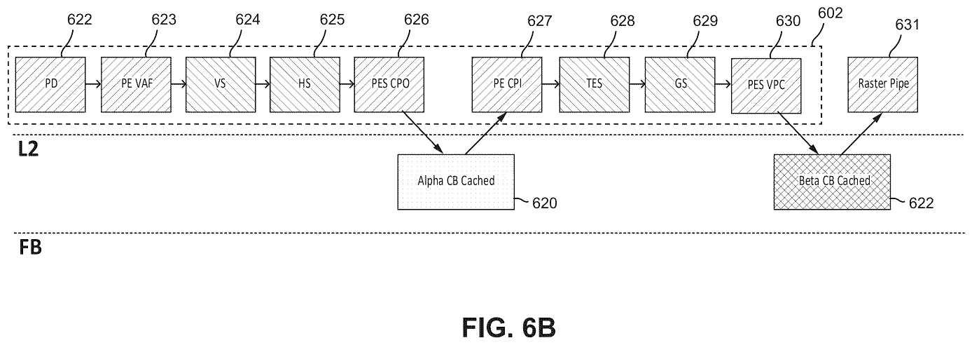

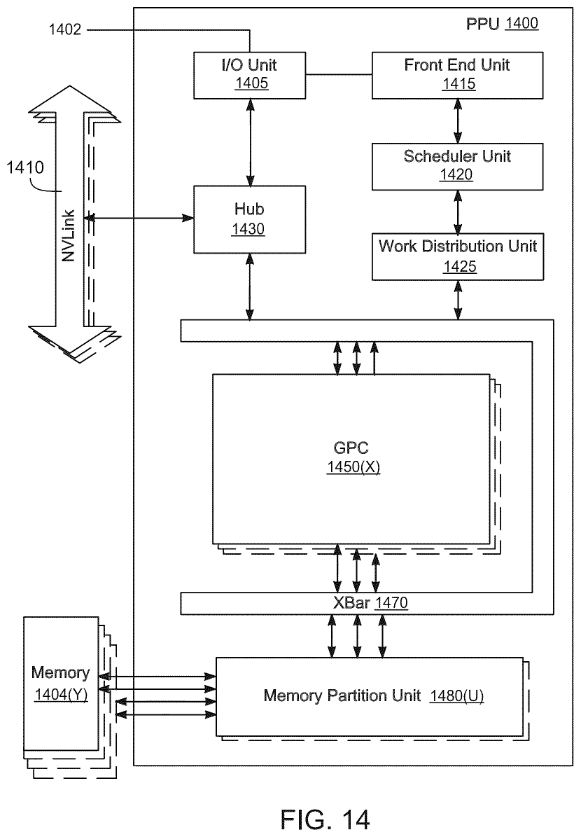

FIG. 6A shows an example graphics processing pipeline 600 that may be implemented within multi-chip GPU 400, according to one embodiment of the present invention. The graphics processing pipeline 600 includes, without limitation, a primitive distributor (PD) 605; a vertex attribute fetch unit (VAF) 606; a vertex, tessellation, geometry processing unit (VTG) 607; a viewport scale, cull, and clip unit (VPC) 608; a tiling unit 609, a setup unit (setup) 610, a rasterizer (raster) 612; a fragment processing unit, also identified as a pixel shading unit (PS) 613, and a raster operations unit (ROP) 614. The PD 605 collects vertex data associated with high-order surfaces, graphics primitives, and the like, from the front end (see FIG. 14). U.S. Pat. No. 8,704,826, herein incorporated by reference in its entirety, describes the pipeline 600 in more detail.

The graphics processing pipeline 600 may be divided into a world space pipeline 602 and a screen space pipeline 604. The world space pipeline 602 processes graphics objects in 3D space, where the position of each graphics object is known relative to other graphics objects and relative to a 3D coordinate system. The screen space pipeline 604 processes graphics objects that have been projected from the 3D coordinate system onto a 2D planar surface representing the surface of the display device. In some embodiments, the world space pipeline 602 may be further divided into an alpha phase pipeline and a beta phase pipeline. For example, the alpha phase pipeline could include pipeline stages in the graphics processing pipeline 600 from the PD 605 through the task generation unit. The beta phase pipeline could include pipeline stages in the graphics processing pipeline 600 from the topology generation unit through the VPC 608.

The tiling unit 609 is a graphics primitive sorting engine that resides between a world space pipeline 602 and a screen space pipeline 604. Graphics primitives are processed in the world space pipeline 602 and then transmitted to tiling unit 609. The screen space is divided into cache tiles, where each cache tile is associated with a portion of the screen space. For each graphics primitive, the tiling unit 609 identifies the set of cache tiles that intersect with the graphics primitive, and stores the primitive in a per-tile “bin” for each such cache tile, a process referred to herein as “tiling.” After tiling a certain number of graphics primitives, tiling unit 609 traverses the set of cache tiles, and for each cache tile it processes, the graphics primitives associated with that particular cache tile are retrieved from it's respective “bin” and provided to the setup unit 610. The tiling unit 609 transmits graphics primitives to the setup unit 610 one cache tile at a time. Graphics primitives that intersect with multiple cache tiles are typically processed once in the world space pipeline 602, but are, depending on the number of cache tiles they intersect with, then transmitted one or more times to the screen space pipeline 604.

### Localization of Vertex Attributes Writes

Vertex attributes define geometry—the pieces of data associated with each vertex (a point) in a 3D model comprising polygons such as triangles. Complex scenes are now made of many millions of triangles, and per-vertex attributes include the 3D x, y and z coordinates of each vertex of each triangle being rendered in the 3D scene. In addition to the x, y and z attributes specifying the position of the vertex in 3D space, the set of per-vertex attributes usually include other parameters (e.g. vertex color, texture u, v coordinates, and the like) that are required for rendering the triangle on the screen. The vertex attributes thus provide the information needed by a processor to render the model accurately and realistically. They are processed by the vertex shader and used throughout the graphics pipeline to determine the appearance of the final image. For example, different subsets of the vertex attributes may be processed in the vertex shader, tessellation shader, geometry shader, rasterization, and fragment shader stages of the graphics pipeline. To parallelize rendering of a single polygon defined by the vertices across a plurality of GPCs, the entire screen is subdivided using a checkerboard pattern into a number of screen tiles, where each GPC's Raster Engine has an exclusive subset of those screen tiles designated to that GPC for rendering into, and where the union of all GPC's subsets of screen tiles makes up the entire screen. Thus, to render a polygon, each GPC responsible for any screen tiles that the intended fully rasterized polygon would intersect, must have access to the vertex attributes of that polygon.

Each SM can process primitive data through a number of different programmable shader stages. From a programming model point of view, the entire 3D graphics pipeline can be thought of as a sequence of processing stages individually enabled from a fixed-order set of programmable shader stages and fixed-function processing stages. During the rendering of an image, as vertex attributes for millions of vertices are being processed in a graphics pipeline, some stages of the graphics pipeline may provide its output to a subsequent shader stage that will be handled in the same SM (i.e. via an ISBE) or to a subsequent shader stage that will be handled after redistributing the work to an SM of a potentially different GPC (i.e. via alpha or beta CBE), by writing that output to a buffer such as, for example, a circular buffer. As is well known, a circular buffer is a data structure that efficiently manages a fixed-size buffer by treating it as a circular array. The circular buffers operate as sort of “revolving doors” that keep data flowing from one graphics stage to the next. In a circular buffer, when the end of the buffer is reached, the next write operation starts back at the beginning, overwriting the oldest data.

FIG. 6B shows the graphics world pipeline 602 can comprise two stages of circular buffers: alpha (initial) buffers 620 and beta (later) buffers 622. As shown in FIG. 6B, the alpha and beta circular buffers are allocated in video memory and are expected to be cached in L2. They are used to communicate vertex attributes (as well as other information) at expansion points in the graphics pipeline. In the example shown, the alpha and beta circular buffers may operate as part of the primitive engine shared (PES) 626 and 630 of a world pipe section 602 supported by a primitive engine 623 and 627. The alpha buffer caches the results of PES CPO 626 based on PD (Primitive Distributor index fetches from the index buffer) 622, PE VAF (Vertex Attribute Fetch) 623, VS (vertex shader) 624, and HS (hull shader) 625 operations, and provides those results to a next stage comprising PE copy in (PE CPI) 627, TES (tessellation evaluation shader) 628, GS (geometry shader) 629 and PES VPC (clip and cull) 630 operations. The output of PES VPC is cached by a next stage beta circular buffer 622, which provides the output to the screen pipe's 604 rasterization engine 631. This redistribution is necessary because on the screen side the distribution of work is based on raster tiles and, as noted above, these are based on GPCs, and therefore based on fixed mappings of GPCs. Where the data is sent depends on where a point is on the screen (e.g., which GPCs would process the primitive depends on which raster tiles that primitive intersects). See e.g., U.S. Pat. No. 8,704,826.

The circular buffers decouple the different segments of the graphics pipeline to avoid stalling. Each instance of a primitive engine shared (PES) unit, which is highly replicated in the uGPU, has an associated circular buffer manager (CBMGR), and has its own alpha and beta circular buffers. These circular buffers are allocated from a pool of memory in the video memory that is reserved for circular buffers. Writes to circular buffers are performed by the PES unit. In some embodiments, the SM may directly write to the alpha circular buffer.

In prior systems, the alpha circular buffer and the beta circular buffer for a graphics pipeline could be located anywhere (i.e., in the locally connected memory of any one of the uGPU in the multi-chip GPU) in the common unified memory space. When the circular buffer, or the circular buffer entry (CBE), to which this data is written is in the locally attached memory of another uGPU on another die, a substantial amount of accesses to those buffers is made over the inter-uGPU connection (e.g., C2C or chip-to-chip connection), thereby consuming a substantial part of the inter-uGPU bandwidth. In addition to consuming a substantial portion of the inter-uGPU bandwidth, such write operations can incur a higher latency because writes to the locally connected memory of another uGPU on another die generally take longer to be acknowledged. It is important for writes to be acknowledged because it is necessary to ensure that the writes are globally visible to the next stage in the pipeline before work associated with that data is sent to the next stage. One way to do that is to wait for the writes to be acknowledged, which means they have reached the POC, and then send the work to the next stage that references that data. Longer latencies for write operations in the pipeline can result in additional chip area being required for latency-hiding in the pipeline.

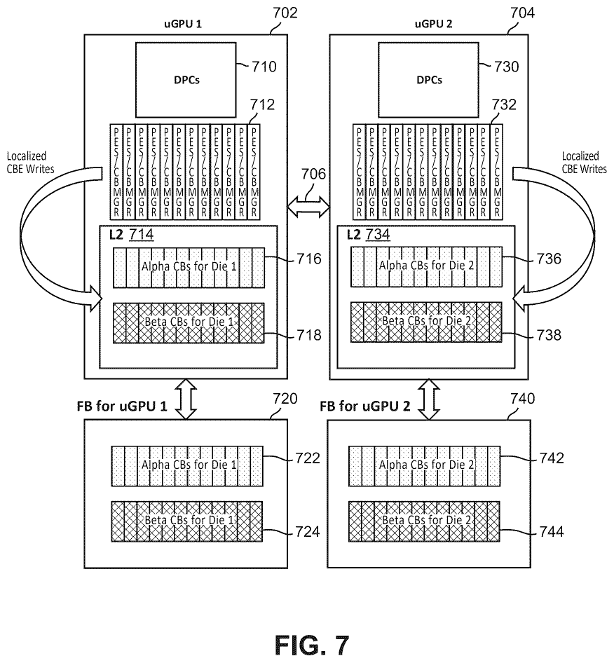

FIG. 7 shows a dual-chip GPU having uGPUs 702 and 704 disposed on respective dies. uGPU1 includes a plurality of GPCs each comprising a plurality data processing clusters (DPC) 710, a plurality of graphics pipelines 712 and an L2 cache 714, and is locally connected to framebuffer memory 720. uGPU2 includes DPC 730, a plurality of graphics pipelines 732 and an L2 cache 734, and is locally connected to framebuffer memory 740. The graphics pipelines 712 of each uGPU includes a world pipeline followed by a screen pipeline (e.g., as shown in FIGS. 6A-B). The screen pipeline performs calculations that are specific to a particular frame buffer tile that uGPU's pixel engine is assigned to render. The world pipe performs calculations that are non-specific to that particular assigned frame buffer tile. For example, world space computation may be performed once for each graphics object regardless of how many screen cache tiles that graphics object intersects. The world space pipeline processes graphics objects associated with an image being rendered in the graphics processing pipeline, and creates graphics primitives associated with the graphics objects. Tiling infrastructure receives graphics primitives and tiles the graphics primitives into screen space tiles. The vertex attribute data stored in the circular buffer includes various attributes associated with the vertices of the graphics primitives processed by the world space pipeline. In such prior architectures, the circular buffers were cached in local L2 caches and allowed to spill into locally connected video memory. See e.g., FIG. 5 of U.S. Pat. No. 8,704,826.

Some embodiments herein provide for the alpha and beta circular buffers (722 and 724 in uGPU1 and 742 and 744 in uGPU2) to—in the first instance—be allocated in the locally connected video memory (framebuffer memory) of the uGPU in which the PES unit (in 712 of uGPU1 and in 732 of uGPU2) that writes to those circular buffers resides. In this manner, when a CBE is written for the alpha or beta circular buffer, the writes go directly to the point of coherence (POC) L2 buffers (716 and 718 in uGPU1 and 736 and 738 in uGPU2) and thus do not need to be written through across the inter-uGPU C2C interface 706 to the other uGPU on another die. FIG. 7 shows that the alpha and beta circular buffers are allocated in framebuffer memory of both uGPUs and are typically cached in the L2 cache of each uGPU. In the context of this disclosure, being localized means the circular buffer that is allocated in a particular video memory does not need to be written by a PES unit on a different uGPU on a different die. Stated another way, “localizing” means allocating its physical address to be in the locally connected memory of the uGPU that writes data as opposed to the locally connected memory of the uGPU that reads the data. The uGPUs on the other die may read the CBEs it requires from the locally-connected memory of the other uGPU and may cache the CBE in its own L2 cache.

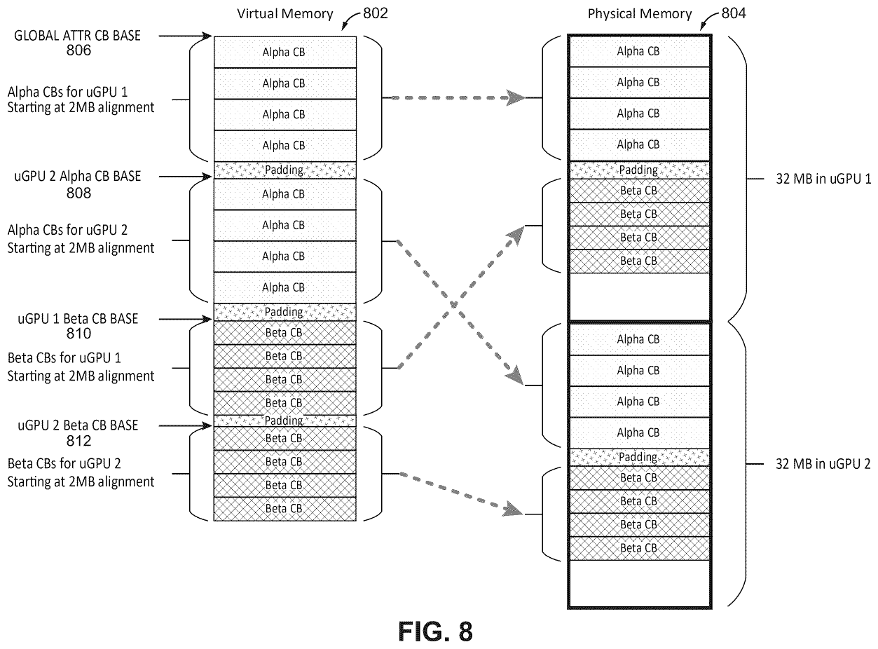

FIG. 8 shows an example configuration of how the localization of FIG. 7 can be achieved. Each circular buffer (i.e., alpha circular buffer and beta circular buffer) has a starting offset with respect to a global attribute circular buffer base 806. The alpha circular buffers and similarly all the beta circular buffers that are for uGPU1 are allocated contiguously with padding of memory to ensure the corresponding alpha and beta circular buffers for uGPU2 start at a 2 MB page alignment. In the virtual memory 802, alpha buffers for uGPU1 start at VA 806 and beta buffers for uGPU1 start at VA 810, and alpha buffers for uGPU2 start at VA 808 and beta buffers for uGPU2 start at VA 812. Both the alpha and beta circular buffers for uGPU1 map to a 32 MB region that is physically allocated in uGPU1, and similarly for uGPU2. In most embodiments the allocation for the circular buffers requires only one 32 MB region in each uGPU, as shown in physical memory 804. Even if more memory is needed, it can be mapped to more 32 MB regions that belong to the same uGPU. FIG. 8 illustrates an example localizing of circular buffers through the use of padding and alignment to 2 MB pages where necessary.

To obtain the optimal benefit of localization for writes of vertex attributes, one example embodiment invalidates the remote copies of the data when they are no longer needed, and before the buffers are recycled and re-written again. Some example embodiments implement CBE invalidation when a CBE is freed to obtain the lower write acknowledge latency benefit.

For example, in the normal course of operation, a CBE that is localized to uGPU1 in a two-chip GPU may be read by both uGPU1 and uGPU2. For example, uGPU1 may need to read world pipe information that uGPU2 has written into its locally stored circular buffers, and vice versa. When uGPU2 reads the CBE across the C2C connection the CBE, in addition to being cached in the L2 cache of uGPU1, is also cached in the L2 cache of uGPU2. Thus, the CBE can be cached in the remote uGPU. In the traditional course of operation, when the CBE is being overwritten by a new write request (e.g., circular buffers are fixed-size buffers), the L2 cache of uGPU1 invalidates the copies of the CBE cached on other L2 cached (i.e., the L2 cache of uGPU2), before acknowledging the write request. This increases the delay for the uGPU1 L2 cache to acknowledge the write request to the PES, thus increasing the latencies in the pipeline. Since uGPU1 often frees the CBE data before that CBE is needed to be overwritten, invalidating the CBE memory when the CBE is freed ensures that copies of the data in the remote uGPU are invalidated before the CBE is re-used and written with new data. This allows POC L2 cache to return write acknowledgements right away without having to wait for data in remote L2 caches to be invalidated.

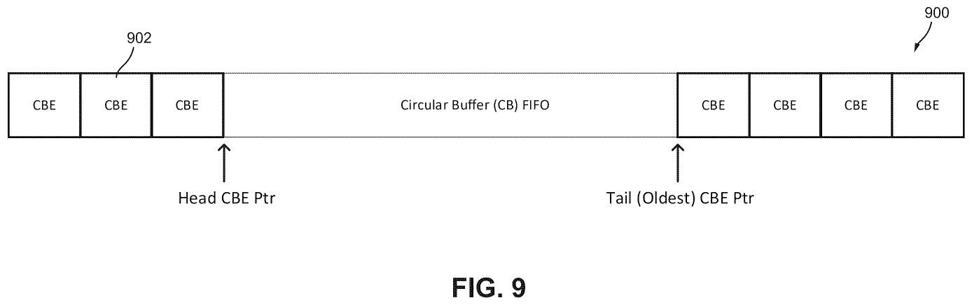

In some embodiments, when a CBE entry is freed, the CBMGR instructs the PES unit to send invalidate commands to L2. The CBMGR may include a counter associated with each CBE, that when the counter goes to 0 the CBMGR knows that the buffer is no longer in use and initiates sending of the free buffer/recycle signal to L2 cache. Since the PES unit is also the unit that writes the CBE, these invalidate commands remain in-order with respect to writes from the PES unit that may follow. The PES unit sends invalidate commands to the L2 cache of its uGPU for that entry on behalf of CBMGR. The L2 cache receives the invalidate command from the PES, and transmits an invalidate command to remote caches for that CBE. The L2 cache tracks cached entries, and then sends the invalidate to the other L2s. The PES unit may send an invalidate acknowledge back to CBMGR after sending the invalidate commands, and the CBMGR unit may then allocate the space to a new CBE. This order of transactions ensures that new writes to a re-allocated CBE come after the invalidates are sent. It should be noted that even if this order of transactions is reversed, the functionality is maintained but with a higher write latency. FIG. 9 illustrates a circular buffer FIFO 900 with Circular Buffer Entries (CBEs) 902. New CBEs are added at the head CBE pointer and the oldest entries that are no longer needed are freed at the tail CBE pointer.

There are two goals with such localization of alpha and beta circular buffers: lower latency write acknowledgements from the local L2 cache, and elimination of the inter-uGPU traffic due to write to the circular buffers.

Lower latency write acknowledgments from the local L2 cache are important as the PES and the work distribution (WWDX) unit does not collectively forward primitives to the raster pipe until the write acknowledgments have been received because otherwise, incomplete world pipe information may be forwarded to the raster pipe. This would help reduce the latency hiding that is required in the pipeline (e.g., in the WWDX unit) and consequently reduce the requirements for chip area for latency hiding.

The reducing of inter-uGPU write bandwidth (e.g., bandwidth across the inter-uGPU C2C connection) consumption between the uGPUs generally helps performance and power. In typical workloads, circular buffer writes are typically more frequent than circular buffer reads due to pipeline operations such as depth culling in Z cull and other Z optimizations that results in some circular buffer data never being read by either uGPU. On the other hand, for a large polygon covering many screen tiles, the circular buffer data may need to be read by multiple GPCs of the remote uGPU, which may result in multiple inter-uGPU reads. However, it is deemed to be net improvement in performance since the vast majority of polygons in a typical application are relatively small. Thus, although reducing write latency by localizing writes can come at the expense of increasing read latency, the localizing of writes in embodiments provide a net improvement in performance in most applications.

In some embodiments, the invalidating of the CBEs when they are freed (and before the need to be reused) enables the system to get the full benefit of reduced write ack L2 cache latency. This is because the circular buffer data is highly likely to be read by both uGPUs and thus cached in the L2 cache of the remote uGPU as well as cached in the L2 cache of the local uGPU. When an invalidate is sent, it removes the cached line in the remote uGPU. By invalidating the space of freed CBEs well before they are re-allocated to new CBEs, there is a certainty or, in some embodiments, at least a high likelihood that when the new CBEs are written, there is no stale data cached in the remote uGPU, and this allows the local uGPU L2 cache to return a write acknowledgments right away, thus reducing local L2 cache write Ack latency. By invalidating CBEs earlier (i.e. as the allocation is freed because the data is no longer needed, rather than when it needs to be re-allocated for writing new data), the L2 cache lines getting invalidated could (in some embodiments i.e. if not tagged as evict-last) become available for caching unrelated data, thereby improving performance by effectively making the cache appear larger. This can become a more significant advantage for the circular buffers that are, for conservative reasons, given a larger allocation than might actually be required for a particular application's workload.

In some embodiments, the circular buffer memory is allocated locally to a uGPU using the implementation described in relation to FIG. 5B, which supports course grain (e.g., 32 MB) interleaving of physical memory, and by the driver making virtual address to physical address page mappings (e.g., 2 MB page mappings) that map circular buffer memory to the local physical memory (e.g., point into one of the 32 MB regions that is physically local). The size (e.g., 2 MB) of the mappings may be determined based on Page Table Entry (PTE) structure in the GPU's hardware MMU(s). In some embodiments, the localization of vertex attributes is implemented in the resource manager (RM) through a combination of: support of course grain interleaving as described in relation to FIG. 5B, virtual address to physical address (VA->PA) page mappings (e.g., 2 MB page mappings) to the appropriate PA in a particular uGPU, and RM programming of an alpha circular buffer offset register and a beta circular buffer offset register in CBMGR units in such a way that guarantees that alpha and beta circular buffers will be localized, as illustrated in FIG. 8.

With respect to programming of the alpha circular buffer offset and the beta circular offset registers in each CBMGR unit, as shown in FIG. 8, the global circular buffer base address (based on which the offsets for the alpha and beta CBs are specified) may be PTE-page aligned (e.g., 2 MB naturally aligned) in VA space.

In some embodiments, the RM may allocate circular buffers for units in a particular uGPU contiguously so that alignment to PTE pages (2 MB naturally aligned addresses) is only needed at the beginning of a per-uGPU allocation. The RM may pad the allocation of each uGPU for each of alpha and beta circular buffers such that the allocation for the other uGPU starts at a page alignment (e.g., 2 MB naturally aligned addresses) in VA space. Similarly, RM may add padding between alpha and beta circular buffer allocations so that the beta circular buffer allocations start on a (e.g., 2 MB) page alignment. It may be generally expected that aligned pages in VA space map to aligned pages in PA space, which implies that there is also padding in PA space. The VA->PA 2 MB PTEs may point to one of the 32 MB physical memory chunks on the same uGPU as the CBMGR units.

### Localization of Page Pool and RTV Circular Buffers

Two types of constants are communicated between uGPUs in a multi-chip GPU: constants such as RTV, and constant buffers. Constant buffers are allocated and managed by the graphics API for conveying constant buffer data to the shaders. The page pool is a hardware-managed circular buffer in the GPU's virtual memory address space, that is used by the hardware SCC unit for handling in-band constant buffer update methods. Space for the page pool circular buffer is allocated by the RM when a context is initialized and the location of initial allocation of the circular buffer is conveyed to SCC by writing its configuration registers. However, individual page pool entries (also known as page pool pages), are allocated and written by the SCC unit based on the input stream and the availability of free entries in the page pool. Likewise, deallocation of a pool page is also managed by the SCC unit based on dynamic information from the shaders that guarantees that the data within a pool page is no longer needed by any shader. These pages can be used to store various types of constant data. Root Tables are another API-visible mechanism for conveying constant data to shaders. A Root Table can be updated by the API, requiring the hardware to create a version of that root table for new instances of shader launches in order to not stall until all previous instances of shaders have completed. The SCC allocates root table versions (RTV) as entries from a single RTV circular buffer. Similar to the page pool circular buffer, the RTV circular buffer is allocated by the RM at context initialization time and the location is conveyed to SCC by writing its configuration registers. Also, similarly to how SCC manages freeing and deallocation of pool pages, SCC can free up RTV CBEs based on dynamic information that guarantee that older root table versions will never need to be read by the shader.

In some embodiments, alone or in addition with the localizing of vertex attributes, the localization of page pool and RTV buffers is provided. Similar to with the localization of the vertex attributes, the goal of localizing page pool and RTV buffers also includes reducing write acknowledgment latency for writes from the SCC to the page pool and RTV circular buffers, and avoiding the latency of write acknowledgments from remote uGPUs.

Although the mechanism for localizing page pools and RTV buffers is similar to that of localizing vertex attributes, one difference is that these circular buffers are being localized to the SCC unit that writes these circular buffers and which resides in just one uGPU. The SCC unit is responsible for handling constants in the graphics pipe, and is thus the only unit writing this data. The goal is to reduce write acknowledge latency so that it is always a local uGPU L2 cache write acknowledge latency, and not a remote uGPU write acknowledge latency which would be significantly higher due to uGPU crossing latency. Reducing the write acknowledge latency is important as stalls introduced in the SCC in the front of the pipe lead to reduced scalability in performance of the overall GPU.

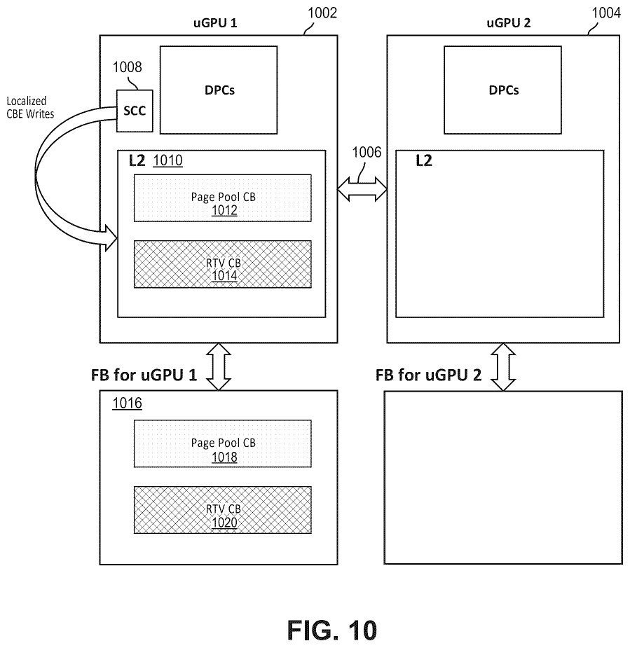

FIG. 10 illustrates a multi-chip GPU with the page pool and RTV circular buffers localized, in accordance with some embodiments. The figure shows that the page pool and RTV circular buffers must be allocated in the framebuffer memory of the same uGPU where the SCC is executing in the graphics pipeline (i.e. the uGPU that drives the whole multi-uGPU GPU). The video memory for the page pool and RTV circular buffers is allocated in the video memory/FB of the same uGPU where the actively used SCC in a dual-uGPU system resides. As shown in the two-chip GPU in which uGPUs 1002 and 1004 on respective dice have a C2C connection 1006, page pool 1018 and RTV buffer 1020 in framebuffer memory 1016 (also cached to 1012 and 1014 in L2 1010) of uGPU1 1002 which has the active SCC 1008.

Since the data written in these circular buffers can be accessed by the second uGPU, the data may be cached in the L2 cache of the second uGPU as well. In order to get the benefit of lower latency write acknowledgements from the local L2 cache, the SCC must invalidate the page pool and RTV circular buffer entries that are no longer in use. Invalidation has the effect of removing copies of these circular buffers that may be cached in the second uGPU's L2 cache. If invalidation happens earlier than when the circular buffers are written again at the same addresses, then the effect is that the write acknowledgments will have a lower latency since they come directly from the local L2 cache.

Both the global and per context page pool and RTV circular buffers may be localized.

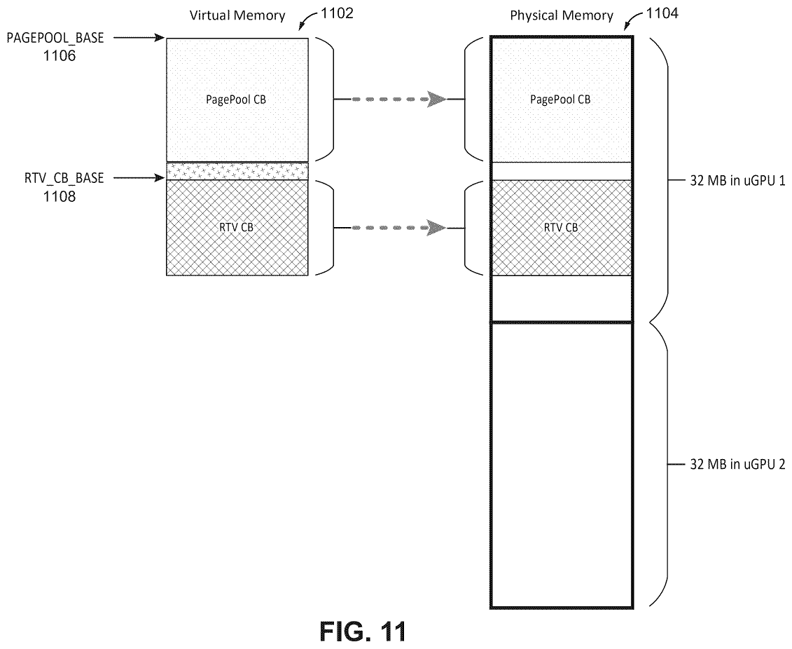

Similar to the localizing of vertex attributes described above, in some embodiments the page pool and RTV circular buffer memory is allocated locally to a uGPU using the course grain (e.g., 32 MB) interleaving of physical memory described above in relation to FIG. 5B, and by the driver making VA->PA (e.g., 2 MB) page mappings that map circular buffer memory to the local physical memory e.g., point into one of the 32 MB regions that is physically local. This is illustrated in FIG. 11. FIG. 11 illustrates an example configuration to localize the page pool and RTV circular buffers at pagepool base address 1106 and RTV buffer base address 1108 in virtual memory 1102 is localized to the 32 MB in uGPU1. The active SCC resides in uGPU1 1002.

The RM may allocate the page pool and RTV circular buffers in the same uGPU as the SCC. Like in the implementing of the vertex localization, invalidation of freed CBE entries may be critical since the data will be read and cached by both uGPUs. The SCC unit (a hardware unit) may initiate the invalidation of freed CBE for the page pools and for RTV buffers.

Additionally, in some embodiments, constant buffers (e.g., buffers storing constants) are localized. Such localizing would reduce write acknowledge latency for a constant buffer write, which, in the most common use case, requires that a prior corresponding page pool write acknowledgment to have been received. Constants are visible to all uGPUs in the system. In some embodiments, constants are localized to the uGPU which has the active SCC (similar to page pools and RTV localization).

In multi-chip GPUs, constant buffers can in general be anywhere in memory, not necessarily localized. In the case that there are constant buffer updates, even if the constant buffer is located in the memory local to the GPU with the active SCC, there can be no reduction in the write ack latency for SCC's constant buffer write because the SCC cannot issue a prior L2 cache invalidation (that can go to the remote GPU) to the address corresponding to the location of constant buffer write. Thus, the constant buffer write will always need wait for remote acknowledgment. This can incur a performance penalty, but advantageously for typical applications, constant buffer updates are less frequent compared to RTV updates. However, the graphics driver can, if so configured, localize the constant buffers using the course grain (e.g., 32 MB) interleaving described in relation to FIG. 5B.

### Localization of SM Local Memory

The SM local memory is the memory used by each SM for data sharing among threads in a warp executing on that SM and for storing temporary data (e.g., intermediate results). In existing multi-chip GPUs, the SM local memory of an SM may be located on a different die than the die where that SM is located. Because the SM local memory is written into frequently, when the SM local memory of an SM is on the locally connected memory of another uGPU, unnecessary inter-uGPU traffic may be generated. By localizing the SM local memory of an SM, such inter-uGPU write traffic can be reduced or eliminated.

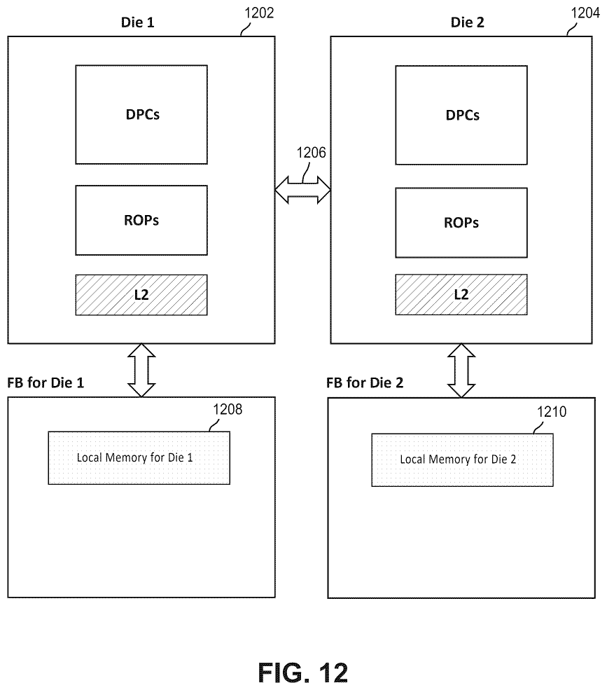

FIG. 12 shows a two-chip GPU with the SM local memory localized, according to some embodiments. The SM local memory 1208 for uGPU1 on die1 1202 is allocated in the locally connected framebuffer memory, and SM local memory 1210 for uGPU2 on die2 1204 (dice 1202 and 1204 connected C2C 1206) is allocated in the locally connected framebuffer memory of die2. The SM local memory is allocated in the physical memory of the same die in which it is accessed by SMs.

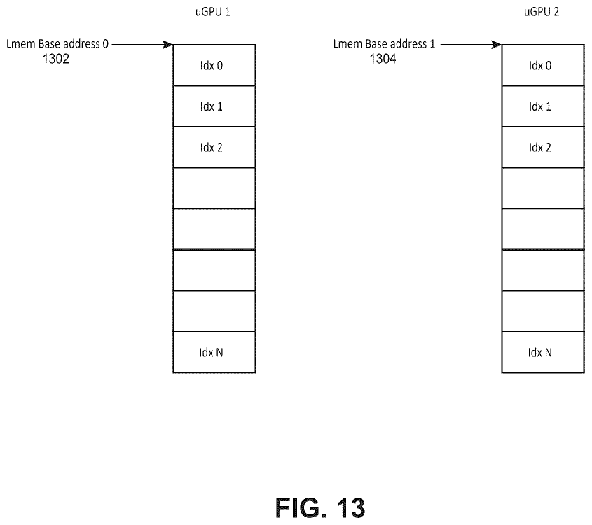

FIG. 13 illustrates an example configuration for the localizing of SM local memory as accomplished by having two SM local memory base addresses 1302 and 1304, one for each of uGPU1 and uGPU2, and SM local memory indices for SMs that are with respect to the base address in the same uGPU. In some embodiments, the driver allocates the SM local memory locally using the course grained interleaving described in relation to FIG. 5B, and VA->PA mappings to the local physical memory.

The goal of localizing SM local memory is to eliminate C2C traffic between two dies that compose a single GPU for local memory accesses. By default, memory may be fine interleaved (see FIG. 5A) between each uGPU. Writes to SM local memory are write through at L1 cache to L2 cache, and also write through at L1 to POC cache. Consequently, without the localization of SM local memory as in this disclosure, a significant portion of SM local memory writes would end up being transferred across the C2C interface between the two dies. By localizing SM local memory, all SM local memory traffic between the two dies can be eliminated.

One of the requirements of the driver is to be able to dynamically grow SM local memory without having to change existing VA->PA mappings, which is hard to do in graphics APIs, and at the same time keep SM local memory local to a die. For example, in order to grow SM local memory without having to change existing VA->PA mappings, the driver may be required to make two smaller allocation calls to two disjoint address spaces instead of a single larger allocation. FIG. 13 shows how localizing SM local memory is accomplished. The basic idea is to have separate SM local memory base addresses for each uGPU, and to assign SM local memory indices to SMs that are with respect to the base address in the same uGPU. Having separate SM local memory base addresses allows the SM local memory to be grown while keeping it local. Having SM local memory indices that are with respect to the appropriate SM local memory base address avoids the double allocation of SM local memory. In some embodiments, the SM local memory may be allocated locally to a die using the course interleaving described in relation to FIG. 5B which supports course grained (e.g., 32 MB) interleaving of physical memory, and by the driver making VA->PA (e.g., 2 MB) page mappings that map SM local memory to the local physical memory, e.g. point into one of the (e.g., 32 MB) regions that is physically local.

To support more easily scaling to more than 2 uGPUs in a GPU, the SM local memory base address for uGPU2 can be specified as having a uGPU stride offset from the SM local memory base address of uGPU1. Then the SM local memory base address for any uGPU can be evaluated as:

$$SM local memory base address of a uGPU = SM local memory global base address + uGPU ID * SM local memory uGPU stride$$

The localization of SM local memory for the graphics pipe may be performed by the DS and SM units. The localization of SM local memory for the compute pipe may be performed by the compute work distributor (CWD) and SM units. The SM may calculate the SM local memory base address depending on which uGPU it resides in (e.g., a uGPU ID number obtained from a hard-coded signal) using a formula, where SM local memory uGPU stride is constrained to a power of 2: SM local memory base address of a uGPU=SM local memory global base address+ (uGPU ID<<Log 2(SM local memory uGPU stride)). Note that when the uGPU ID range starts at 1 (instead of 0), the uGPU ID in the above equations should be uGPU ID−1.

In some embodiments, the RM programs a designated register in each SM with a SM local memory block index to use with respect to the SM local memory base address in each uGPU as shown in FIG. 13 i.e. enumerates all SMs in a uGPU with consecutive SM local memory block index values that start at 0.

In some embodiments, the driver sends the SM local memory uGPU stride via methods in the compute and graphics classes. If the driver does not intend to make use of SM local memory localization, it can send a SM local memory uGPU stride of zero. It should be noted that, when the stride is zero, addresses used by the two uGPUs may overlap unless a) each uGPU is provided a different SM local memory global base address, or b) the RM programs the SM indices across to be all unique across both uGPUs (whereas in the localized case, in both uGPUs the first SM gets index 0, etc.). The driver programs the total size for SM local memory across both uGPUs.

Localization similar to the above can be applied to several other graphics tasks performed by the GPU. For example, in previous GPU systems shader execution reordering was performed to sort rays for improved coherence before the rays are used for intersection testing. In a multi-chip GPU according to some embodiments, the rays can first be evenly divided among the dice, and then the rays can be first sorted on each die separately. For example, in the example two-chip GPU with one uGPU on each die, half the rays can be stored in the locally-attached memory of uGPU1 and sorted by uGPU1, and the other the other half can be stored in the locally-attached memory of uGPU2 and sorted by uGPU2, thereby minimizing C2C bandwidth consumption for the coherence sorting.

### Example GPU Architecture

An example illustrative architecture of a chip/die in a multi-chip GPU described in relation to FIGS. 6-13, is described in accordance with some embodiments. The following information is set forth for illustrative purposes and should not be construed as limiting in any manner. Any of the following features may be optionally incorporated with or without the exclusion of other features described.

FIG. 14 illustrates a parallel processing unit (PPU) 1400 that may be included on a die of a multi-die GPU, in accordance with an embodiment. In an embodiment, the PPU 1400 is a multi-threaded processor that is implemented on one or more integrated circuit devices. The PPU 1400 is a latency hiding architecture designed to process many threads in parallel. A thread (e.g., a thread of execution) is an instantiation of a set of instructions configured to be executed by the PPU 1400. In an embodiment, the PPU 1400 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 1400 may be utilized for performing general-purpose computations. In some other embodiments, PPU 1400 configured to implement large neural networks in deep learning applications or other high performance computing applications.

One or more PPUs 1400 may be configured to accelerate thousands of High Performance Computing (HPC), data center, and machine learning applications. The PPU 1400 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 14, the PPU 1400 includes an Input/Output (I/O) unit 1405, a front end unit 1415, a scheduler unit 1420, a work distribution unit 1425, a hub 1430, a crossbar (Xbar) 1470, one or more general processing clusters (GPCs) 1450, and one or more partition units 1480. The PPU 1400 may be connected to a host processor or other PPUs 1400 via one or more high-speed NVLink 1410 interconnect. The PPU 1400 may be connected to a host processor or other peripheral devices via an interconnect 1402. The PPU 1400 may also be connected to a memory comprising a number of memory devices 1404. In an embodiment, the memory 1404 may comprise a number of dynamic random access memory (DRAM) devices. The DRAM devices may be configured as a high-bandwidth memory (HBM) subsystem, with multiple DRAM dies stacked within each device.

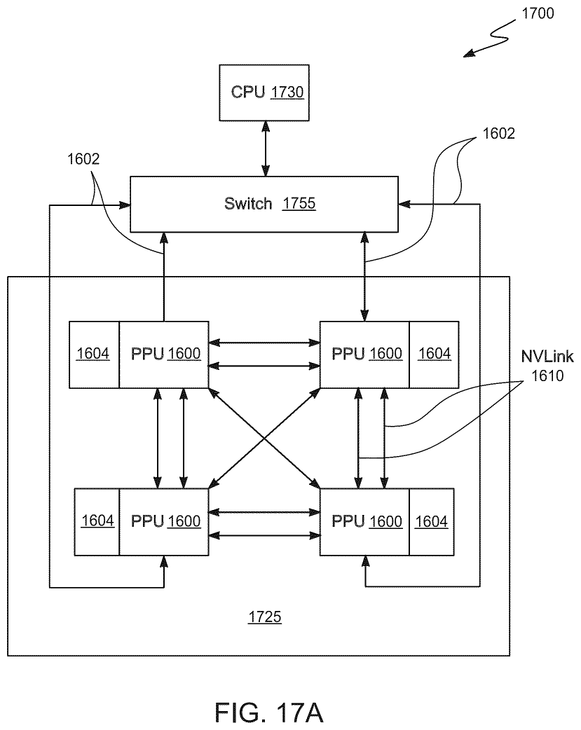

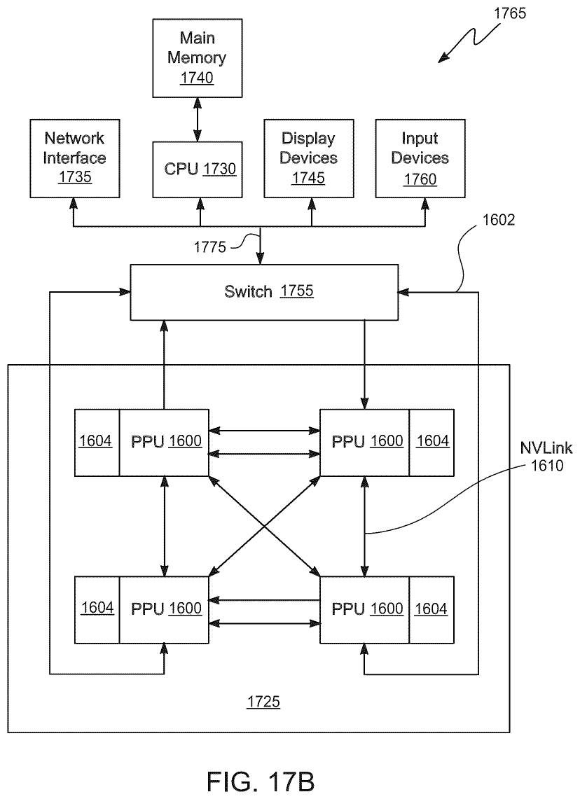

The NVLink 1410 interconnect enables systems to scale and include one or more PPUs 1400 combined with one or more CPUs, supports cache coherence between the PPUs 1400 and CPUs, and CPU mastering. Data and/or commands may be transmitted by the NVLink 1410 through the hub 1430 to/from other units of the PPU 1400 such as one or more copy engines, a video encoder, a video decoder, a power management unit, etc. (not explicitly shown). The NVLink 1410 is described in more detail in conjunction with FIG. 17A and FIG. 17B. However, the interconnect 1410 is not limited to using NVLink.

The I/O unit 1405 is configured to transmit and receive communications (e.g., commands, data, etc.) from a host processor (not shown) over the interconnect 1402. The I/O unit 1405 may communicate with the host processor directly via the interconnect 1402 or through one or more intermediate devices such as a memory bridge. In an embodiment, the I/O unit 1405 may communicate with one or more other processors, such as one or more of the PPUs 1400 via the interconnect 1402. In an embodiment, the I/O unit 1405 implements a Peripheral Component Interconnect Express (PCIe) interface for communications over a PCIe bus and the interconnect 1402 is a PCIe bus. In alternative embodiments, the I/O unit 1405 may implement other types of well-known interfaces for communicating with external devices.

The I/O unit 1405 decodes packets received via the interconnect 1402. In an embodiment, the packets represent commands configured to cause the PPU 1400 to perform various operations. The I/O unit 1405 transmits the decoded commands to various other units of the PPU 1400 as the commands may specify. For example, some commands may be transmitted to the front end unit 1415. Other commands may be transmitted to the hub 1430 or other units of the PPU 1400 such as one or more copy engines, a video encoder, a video decoder, a power management unit, etc. (not explicitly shown). In other words, the I/O unit 1405 is configured to route communications between and among the various logical units of the PPU 1400.

In an embodiment, a program executed by the host processor encodes a command stream in a buffer that provides workloads to the PPU 1400 for processing. A workload may comprise several instructions and data to be processed by those instructions. The buffer is a region in a memory that is accessible (e.g., read/write) by both the host processor and the PPU 1400. For example, the I/O unit 1405 may be configured to access the buffer in a system memory connected to the interconnect 1402 via memory requests transmitted over the interconnect 1402. In an embodiment, the host processor writes the command stream to the buffer and then transmits a pointer to the start of the command stream to the PPU 1400. The front end unit 1415 receives pointers to one or more command streams. The front end unit 1415 manages the one or more streams, reading commands from the streams and forwarding commands to the various units of the PPU 1400.

The front end unit 1415 is coupled to a scheduler unit 1420 that configures the various GPCs 1450 to process tasks defined by the one or more streams. The scheduler unit 1420 is configured to track state information related to the various tasks managed by the scheduler unit 1420. The state may indicate which GPC 1450 a task is assigned to, whether the task is active or inactive, a priority level associated with the task, and so forth. The scheduler unit 1420 manages the execution of a plurality of tasks on the one or more GPCs 1450.

The scheduler unit 1420 is coupled to a work distribution unit 1425 that is configured to dispatch tasks for execution on the GPCs 1450. The work distribution unit 1425 may track a number of scheduled tasks received from the scheduler unit 1420. In an embodiment, the work distribution unit 1425 manages a pending task pool and an active task pool for each of the GPCs 1450. The pending task pool may comprise a number of slots (e.g., 32 slots) that contain tasks assigned to be processed by a particular GPC 1450. The active task pool may comprise a number of slots (e.g., 4 slots) for tasks that are actively being processed by the GPCs 1450. As a GPC 1450 finishes the execution of a task, that task is evicted from the active task pool for the GPC 1450 and one of the other tasks from the pending task pool is selected and scheduled for execution on the GPC 1450. If an active task has been idle on the GPC 1450, such as while waiting for a data dependency to be resolved, then the active task may be evicted from the GPC 1450 and returned to the pending task pool while another task in the pending task pool is selected and scheduled for execution on the GPC 1450.

The work distribution unit 1425 communicates with the one or more GPCs 1450 via XBar 1470. The XBar 1470 is an interconnect network that couples many of the units of the PPU 1400 to other units of the PPU 1400. For example, the XBar 1470 may be configured to couple the work distribution unit 1425 to a particular GPC 1450. Although not shown explicitly, one or more other units of the PPU 1400 may also be connected to the XBar 1470 via the hub 1430.

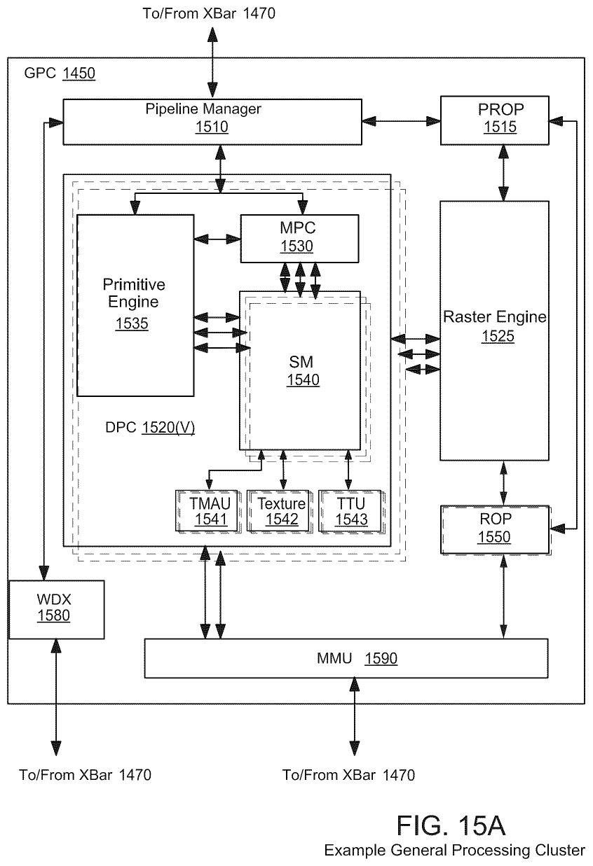

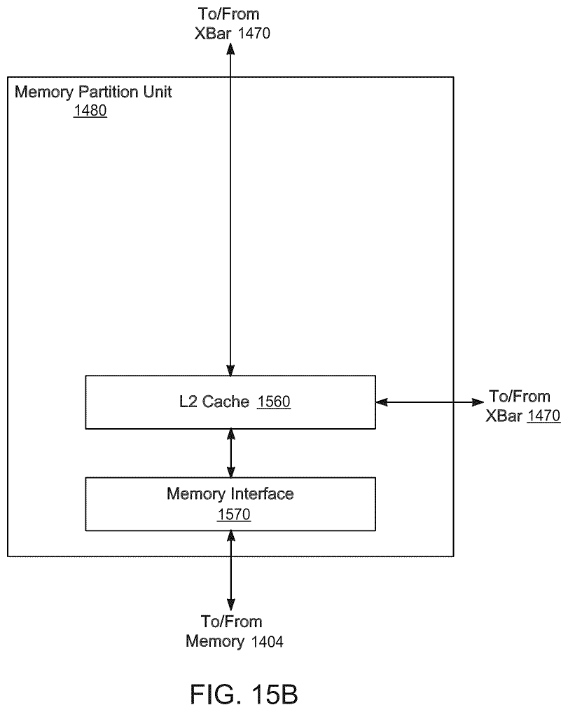

The tasks are managed by the scheduler unit 1420 and dispatched to a GPC 1450 by the work distribution unit 1425. The GPC 1450 is configured to process the task and generate results. The results may be consumed by other tasks within the GPC 1450, routed to a different GPC 1450 via the XBar 1470, or stored in the memory 1404. The results can be written to the memory 1404 via the partition units 1480, which implement a memory interface for reading and writing data to/from the memory 1404. The results can be transmitted to another PPU 1404 or CPU via the NVLink 1410. In an embodiment, the PPU 1400 includes a number U of partition units 1480 that is equal to the number of separate and distinct memory devices 1404 coupled to the PPU 1400. A partition unit 1480 will be described in more detail below in conjunction with FIG. 15B.

In an embodiment, a host processor executes a driver kernel that implements an application programming interface (API) that enables one or more applications executing on the host processor to schedule operations for execution on the PPU 1400. In an embodiment, multiple compute applications are simultaneously executed by the PPU 1400 and the PPU 1400 provides isolation, quality of service (QoS), and independent address spaces for the multiple compute applications. An application may generate instructions (e.g., API calls) that cause the driver kernel to generate one or more tasks for execution by the PPU 1400. The driver kernel outputs tasks to one or more streams being processed by the PPU 1400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory (SMEM). Threads, cooperating threads and a hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety. The SMEM, according to some embodiments, is described in U.S. application Ser. No. 17/691,690, which is hereby incorporated in reference in its entirety.

FIG. 15A illustrates a GPC 1450 of the PPU 1400 of FIG. 14, in accordance with an embodiment. As shown in FIG. 15A, each GPC 1450 includes a number of hardware units for processing tasks. In an embodiment, each GPC 1450 includes a pipeline manager 1510, a pre-raster operations unit (PROP) 1515, a raster engine 1525, a work distribution crossbar (WDX) 1580, a memory management unit (MMU) 1590, and one or more Data Processing Clusters (DPCs) 1520. It will be appreciated that the GPC 1450 of FIG. 15A may include other hardware units in lieu of or in addition to the units shown in FIG. 15A.

In an embodiment, the operation of the GPC 1450 is controlled by the pipeline manager 1510. The pipeline manager 1510 manages the configuration of the one or more DPCs 1520 for processing tasks allocated to the GPC 1450. In an embodiment, the pipeline manager 1510 may configure at least one of the one or more DPCs 1520 to implement at least a portion of a graphics rendering pipeline, a neural network, and/or a compute pipeline. For example, with respect to a graphics rendering pipeline, a DPC 1520 may be configured to execute a vertex shader program on the programmable streaming multiprocessor (SM) 1540. The pipeline manager 1510 may also be configured to route packets received from the work distribution unit 1425 to the appropriate logical units within the GPC 1450. For example, some packets may be routed to fixed function hardware units in the PROP 1515 and/or raster engine 1525 while other packets may be routed to the DPCs 1520 for processing by the primitive engine 1535 or the SM 1540.

The PROP unit 1515 is configured to route data generated by the raster engine 1525 and the DPCs 1520 to a Raster Operations (ROP) unit 1550. The illustrated ROP unit 1550 may comprise a plurality of ROP units. The PROP unit 1515 may also be configured to perform optimizations for color blending, organize pixel data, perform address translations, and the like.

Each DPC 1520 included in the GPC 1450 includes an M-Pipe Controller (MPC) 1530, a primitive engine 1535, and one or more SMs 1540. The MPC 1530 controls the operation of the DPC 1520, routing packets received from the pipeline manager 1510 to the appropriate units in the DPC 1520. For example, packets associated with a vertex may be routed to the primitive engine 1535, which is configured to fetch vertex attributes associated with the vertex from the memory 1404. In contrast, packets associated with a shader program may be transmitted to the SM 1540.

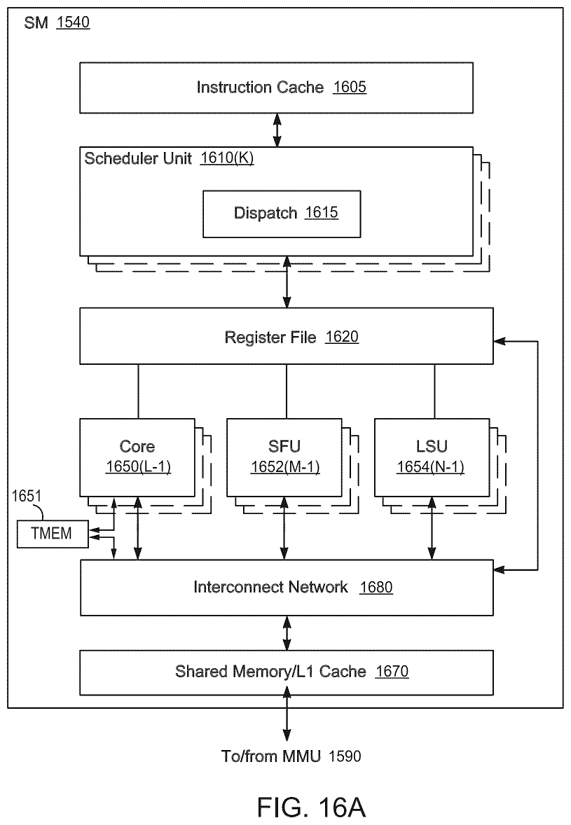

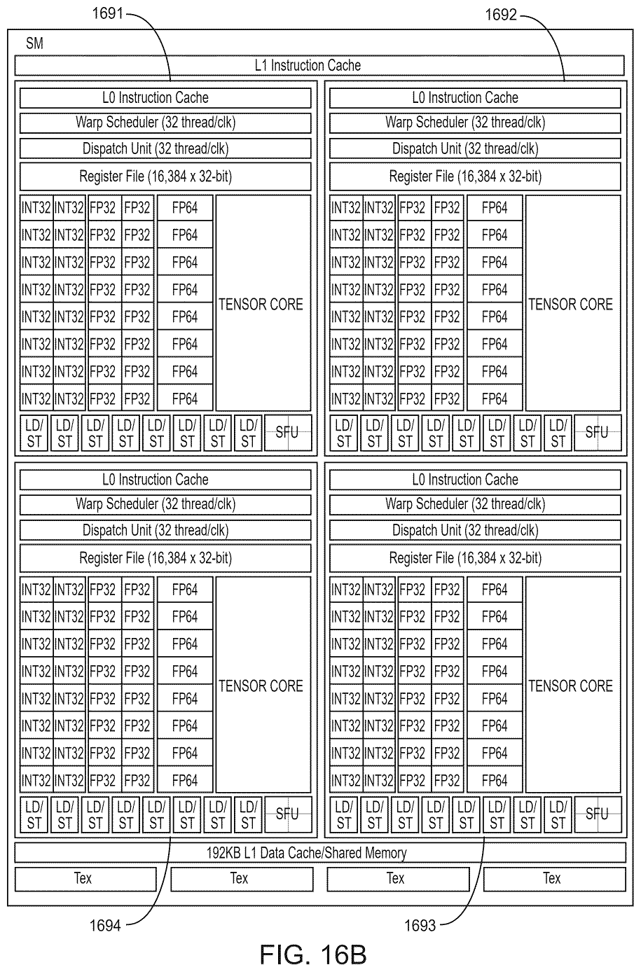

The SM 1540 comprises a programmable streaming processor that is configured to process tasks represented by a number of threads. Each SM 1540 is multi-threaded and configured to execute a plurality of threads (e.g., 32 threads) from a particular group of threads concurrently. In an embodiment, the SM 1540 implements a SIMT (Single-Instruction, Multiple-Thread) architecture where each thread in a group of threads (e.g., a warp) is configured to process a different set of data based on the same set of instructions. All threads in the group of threads execute the same instructions. In another embodiment, the SM 1540 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 1540 is described in more detail below in conjunction with FIG. 16A. FIG. 16B conceptually illustrates four subpartitions 1691-1694 implemented in an SM such as the SM shown in FIG. 16A, according to some embodiments.

The MMU 1590 provides an interface between the GPC 1450 and the partition unit 1480. The MMU 1590 may provide translation of virtual addresses into physical addresses, memory protection, and arbitration of memory requests. In an embodiment, the MMU 1590 provides one or more translation lookaside buffers (TLBs) for performing translation of virtual addresses into physical addresses in the memory 1404.

FIG. 15B illustrates a memory partition unit 1480 of the PPU 1400 of FIG. 14 in accordance with an embodiment. As shown in FIG. 15B, the memory partition unit 1480 includes a level two (L2) cache 1560, and a memory interface 1570. The memory interface 1570 is coupled to the memory 1404. Memory interface 1570 may implement 32, 64, 128, 1024-bit data buses, or the like, for high-speed data transfer. In an embodiment, the PPU 1400 incorporates U memory interfaces 1570, one memory interface 1570 per pair of partition units 1480, where each pair of partition units 1480 is connected to a corresponding memory device 1404. For example, PPU 1400 may be connected to up to Y memory devices 1404, such as high bandwidth memory stacks or graphics double-data-rate, version 5, synchronous dynamic random access memory, or other types of persistent storage.

In an embodiment, the memory interface 1570 implements an HBM2 memory interface and Y equals half U. In an embodiment, the HBM2 memory stacks are located on the same physical package as the PPU 1400, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 824 bits.

In an embodiment, the memory 1404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 1400 process very large datasets and/or run applications for extended periods.

In an embodiment, the PPU 1400 implements a multi-level memory hierarchy. In an embodiment, the memory partition unit 1480 supports a unified memory to provide a single unified virtual address space for CPU and PPU 1400 memory, enabling data sharing between virtual memory systems. In an embodiment the frequency of accesses by a PPU 1400 to memory located on other processors is traced to ensure that memory pages are moved to the physical memory of the PPU 1400 that is accessing the pages more frequently. In an embodiment, the NVLink 1410 supports address translation services allowing the PPU 1400 to directly access a CPU's page tables and providing full access to CPU memory by the PPU 1400.

In an embodiment, copy engines transfer data between multiple PPUs 1400 or between PPUs 1400 and CPUs. The copy engines can generate page faults for addresses that are not mapped into the page tables. The memory partition unit 1480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1404 or other system memory may be fetched by the memory partition unit 1480 and stored in the L2 cache 1560, which is located on-chip and is shared between the various GPCs 1450. As shown, each memory partition unit 1480 includes a portion of the L2 cache 1560 associated with a corresponding memory device 1404. Lower-level caches may then be implemented in various units within the GPCs 1450. For example, each of the SMs 1540 may implement a level one (L1) cache. The L1 cache is private memory that is dedicated to a particular SM 1540. Data from the L2 cache 1560 may be fetched and stored in each of the L1 caches for processing in the functional units of the SMs 1540. The L2 cache 1560 is coupled to the memory interface 1570 and the XBar 1470.

The ROP unit 1550 performs graphics raster operations related to pixel color, such as color compression, pixel blending, and the like. The ROP unit 1550 also implements depth-testing in conjunction with the raster engine 1525, receiving a depth for a sample location associated with a pixel fragment from the culling engine of the raster engine 1525. The depth is tested against a corresponding depth in a depth buffer for a sample location associated with the fragment. If the fragment passes the depth test for the sample location, then the ROP unit 1550 updates the depth buffer and transmits a result of the depth test to the raster engine 1525. Although the ROP unit 1550 is included within the GPC 1450 in FIG. 15B, in another embodiment, the ROP unit 1550 may be outside of the GPC 1450. For example, the ROP unit 1550 may reside in the memory partition unit 1480 or another unit.

FIG. 16A illustrates the streaming multiprocessor 1540 of FIG. 15A, in accordance with an embodiment. As shown in FIG. 16A, the SM 1540 includes an instruction cache 1605, one or more scheduler units 1610, a register file 1620, one or more processing cores 1650, one or more special function units (SFUs) 1652, one or more load/store units (LSUs) 1654, an interconnect network 1680, a SMEM/L1 cache 1670.

As described above, the work distribution unit 1425 dispatches tasks, or more specifically it dispatches one by one the CTAs that make up a task, for execution on the GPCs 1450 of the PPU 1400. The tasks are allocated to a particular DPC 1520 within a GPC 1450 and, if the task is associated with a shader program, the task may be allocated to an SM 1540. The scheduler unit 1610 receives the CTAs that make up a task from the work distribution unit 1425 and manages instruction scheduling for one or more thread blocks assigned to the SM 1540. The scheduler unit 1610 schedules thread blocks for execution as warps of parallel threads, where each thread block consists of at least one warp. In an embodiment, each warp comprises 32 threads. The scheduler unit 1610 may manage a plurality of different thread blocks, allocating the different thread blocks to different warps and then dispatching instructions from the plurality of different cooperative groups to the various functional units (e.g., cores 1650, SFUs 1652, and LSUs 1654) during each clock cycle.

Cooperative Group Arrays (CGAs) provide a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Group Arrays enable programmers to define groups of threads explicitly at sub-block (e.g., as small as a single thread) and multi-block granularities, and to perform collective operations on the threads such as synchronization in a cooperative group. The programming model supports clean composition across software boundaries, so that libraries and utility functions can synchronize safely within their local context without having to make assumptions about convergence. Cooperative Group Array primitives enable new patterns of cooperative parallelism, including producer-consumer parallelism, opportunistic parallelism, and global synchronization across an entire grid of thread blocks. Hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety.

A dispatch unit 1615 is configured to transmit instructions to one or more of the functional units. In the embodiment, the scheduler unit 1610 includes two dispatch units 1615 that enable two different instructions from the same warp to be dispatched during each clock cycle. In alternative embodiments, each scheduler unit 1610 may include a single dispatch unit 1615 or additional dispatch units 1615.

Each SM 1540 includes a register file 1620 that provides a set of registers for the functional units of the SM 1540. In an embodiment, the register file 1620 is divided between each of the functional units such that each functional unit is allocated a dedicated portion of the register file 1620. In another embodiment, the register file 1620 is divided between the different warps being executed by the SM 1540. The register file 1620 provides temporary storage for operands connected to the data paths of the functional units.

Each SM 1540 comprises multiple processing cores 1650. In an embodiment, the SM 1540 includes a large number (e.g., 128, etc.) of distinct processing cores 1650. Each core 1650 may include a fully-pipelined, single-precision, double-precision, and/or mixed precision processing unit that includes a floating point arithmetic logic unit and an integer arithmetic logic unit. In an embodiment, the floating-point arithmetic logic units implement the IEEE 754-2008 standard for floating point arithmetic.

Tensor cores are configured to perform matrix operations, and, in an embodiment, one or more tensor cores are included in the cores 1650. In particular, the tensor cores are configured to perform deep learning matrix arithmetic, such as convolution operations for neural network training and inferencing.

In some embodiments, transposition hardware is included in the processing cores 1650 or another functional unit (e.g., SFUs 1652 or LSUs 1654) and is configured to generate matrix data stored by diagonals and/or generate the original matrix and/or transposed matrix from the matrix data stored by diagonals. The transposition hardware may be provided inside of the SMEM 1670 to register file 1620 load path of the SM 1540.

Each SM 1540 also comprises multiple SFUs 1652 that perform special functions (e.g., attribute evaluation, reciprocal square root, and the like). In an embodiment, the SFUs 1652 may include a tree traversal unit (e.g., TTU 1543) configured to traverse a hierarchical tree data structure. In an embodiment, the SFUs 1652 may include texture unit (e.g., Texture Unit 1542) configured to perform texture map filtering operations. In an embodiment, the texture units are configured to load texture maps (e.g., a 2D array of texels) from the memory 1604 and sample the texture maps to produce sampled texture values for use in shader programs executed by the SM 1540. In an embodiment, the texture maps are stored in the SMEM/L1 cache 1570. The texture units implement texture operations such as filtering operations using mip-maps (e.g., texture maps of varying levels of detail). In an embodiment, each SM 1540 includes two texture units.

Each SM 1540 also comprises multiple LSUs 1654 that implement load and store operations between the SMEM/L1 cache 1670 and the register file 1620. Each SM 1540 includes an interconnect network 1680 that connects each of the functional units to the register file 1620 and the LSU 1654 to the register file 1620, SMEM/L1 cache 1670. In an embodiment, the interconnect network 1680 is a crossbar that can be configured to connect any of the functional units to any of the registers in the register file 1620 and connect the LSUs 1654 to the register file 1620 and memory locations in SMEM/L1 cache 1670.

The SMEM/L1 cache 1670 is an array of on-chip memory that allows for data storage and communication between the SM 1540 and the primitive engine 1535 and between threads in the SM 1540. In an embodiment, the SMEM/L1 cache 1670 comprises 128 KB of storage capacity and is in the path from the SM 1540 to the partition unit 1680. The SMEM/L1 cache 1670 can be used to cache reads and writes. One or more of the SMEM/L1 cache 1670, L2 cache 1560, and memory 1604 are backing stores.

Combining data cache and SMEM functionality into a single memory block provides the best overall performance for both types of memory accesses. The capacity is usable as a cache by programs that do not use SMEM. For example, if SMEM is configured to use half of the capacity, texture and load/store operations can use the remaining capacity. Integration within the SMEM/L1 cache 1670 enables the SMEM/L1 cache 1670 to function as a high-throughput conduit for streaming data while simultaneously providing high-bandwidth and low-latency access to frequently reused data.

In the context of this disclosure, an SM or “streaming multiprocessor” means a processor architected as described in U.S. Pat. No. 7,447,873 including improvements thereto and advancements thereof, and as implemented for example in many generations of NVIDIA GPUs. For example, an SM may comprise a plurality of processing engines or cores configured to concurrently execute a plurality of threads arranged in a plurality of single-instruction, multiple-data (SIMD) groups (e.g., warps), wherein each of the threads in a same one of the SIMD groups executes a same data processing program comprising a sequence of instructions on a different input object, and different threads in the same one of the SIMD group are executed using different ones of the processing engines or cores. An SM may typically also provide (a) a local register file having plural lanes, wherein each processing engine or core is configured to access a different subset of the lanes; and instruction issue logic configured to select one of the SIMD groups and to issue one of the instructions of the same data processing program to each of the plurality of processing engines in parallel, wherein each processing engine executes the same instruction in parallel with each other processing engine using the subset of the local register file lanes accessible thereto. An SM typically further includes core interface logic configured to initiate execution of one or more SIMD groups. As shown in the figures, such SMs have been constructed to provide fast local SMEM enabling data sharing/reuse and synchronization between all threads of a CTA executing on the SM.

When configured for general purpose parallel computation, a simpler configuration can be used compared with graphics processing. Specifically, the fixed function graphics processing units shown in FIG. 15A, are bypassed, creating a much simpler programming model. In the general—=purpose parallel computation configuration, the work distribution unit 1425 assigns and distributes blocks of threads directly to the DPCs 1520. The threads in a block execute the same program, using a unique thread ID in the calculation to ensure each thread generates unique results, using the SM 1540 to execute the program and perform calculations, SMEM/L1 cache 1670 to communicate between threads, and the LSU 1654 to read and write global memory through the SMEM/L1 cache 1670 and the memory partition unit 1680. When configured for general purpose parallel computation, the SM 1540 can also write commands that the scheduler unit 1620 can use to launch new work on the DPCs 1520.

The PPU 1400, or a multi-dielet GPU comprising multiple PPU as described in this disclosure, may be included in a desktop computer, a laptop computer, a tablet computer, servers, supercomputers, a smartphone (e.g., a wireless, hand-held device), personal digital assistant (PDA), a digital camera, a vehicle, a head-mounted display, a hand-held electronic device, and the like. In an embodiment, the PPU 1400 is embodied on a single semiconductor substrate. In another embodiment, the PPU 1400 is included in a system-on-a-chip (SoC) along with one or more other devices such as additional PPUs 1400, the memory 1604, a reduced instruction set computer (RISC) CPU, a memory management unit (MMU), a digital-to-analog converter (DAC), and the like.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever-larger problems. As the number of processing devices within the high-performance systems increases, the communication and data transfer mechanisms need to scale to support the increased bandwidth requirements.

FIG. 17A is a conceptual diagram of a processing system 1700 implemented using multi-dielet GPUs 1600 that include two or more of the PPU 1400 of FIG. 14, in accordance with an embodiment. The exemplary system 1700 may be configured to implement the methods disclosed in this application. The processing system 1700 includes a CPU 1730, switch 1755, and multiple multi-dielet GPUs 1600 and respective memories 1604. The NVLink 1610 provides high-speed communication links between each of the multi-dielet GPUs. Although a particular number of NVLink 1610 and interconnect 1602 connections are illustrated in FIG. 17A, the number of connections to each multi-dielet GPU and the CPU 1730 may vary. The switch 1755 interfaces between the interconnect 1602 and the CPU 1730. The multi-dielet GPUs, memories 1604, and NVLinks 1610 may be situated on a single semiconductor platform to form a parallel processing module 1725. In an embodiment, the switch 1755 supports two or more protocols to interface between various connections and/or links.

In another embodiment (not shown), the NVLink 1610 provides one or more high-speed communication links between each of the multi-dielet GPUs and the CPU 1730, and where the switch 1755 interfaces between the interconnect 1602 and each of the multi-dielet GPUs. The multi-dielet GPUs, memories 1604, and interconnect 1602 may be situated on a single semiconductor platform to form a parallel processing module 1725. In yet another embodiment (not shown), the interconnect 1602 provides one or more communication links between each of the multi-dielet GPUs and the CPU 1730, and where the switch 1755 interfaces between each of the multi-dielet GPUs using the NVLink 1610 to provide one or more high-speed communication links between the multi-dielet GPUs. In another embodiment (not shown), the NVLink 1610 provides one or more high-speed communication links between the multi-dielet GPUs and the CPU 1730 through the switch 1755. In yet another embodiment (not shown), the interconnect 1602 provides one or more communication links between each of the multi-dielet GPUs directly. One or more of the NVLink 1610 high-speed communication links may be implemented as a physical NVLink interconnect or either an on-chip or on-die interconnect using the same protocol as the NVLink 1610.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional off-chip bus implementation. Of course, the various circuits or devices may also be situated separately or in various combinations of semiconductor platforms per the desires of the user. Alternately, the parallel-processing module 1725 may be implemented as a circuit board substrate and each of the multi-dielet GPUs 1600 and/or memories 1604 may be packaged devices. In an embodiment, the CPU 1730, switch 1755, and the parallel processing module 1725 are situated on a single semiconductor platform.

In an embodiment, the NVLink 1610 allows direct load/store/atomic access from the CPU 1730 to each multi-dielet GPU's 1600 memory 1604. In an embodiment, the NVLink 1610 supports coherency operations, allowing data read from the memories 1604 to be stored in the cache hierarchy of the CPU 1730, reducing cache access latency for the CPU 1730. In an embodiment, the NVLink 1610 includes support for Address Translation Services (ATS), allowing the multi-dielet GPU 1600 to directly access page tables within the CPU 1730. One or more of the NVLinks 1610 may be configured to operate in a low-power mode.

FIG. 17B illustrates an exemplary system 1765 in which the various architectures and/or functionalities of the various previous embodiments may be implemented. The exemplary system 1765 may be configured to implement the methods disclosed in this application.

As shown, a system 1765 is provided and includes at least one central processing unit 1730 that is connected to a communication bus 1775. The communication bus 1775 may be implemented using any suitable protocol, such as PCI (Peripheral Component Interconnect), PCI-Express, AGP (Accelerated Graphics Port), HyperTransport, or any other bus or point-to-point communication protocol(s). The system 1765 also includes a main memory 1740. Control logic (software) and data are stored in the main memory 1740 which may take the form of random access memory (RAM).

The system 1765 also includes input devices 1760, the parallel processing system 1725, and display devices 1745, e.g. a conventional CRT (cathode ray tube), LCD (liquid crystal display), LED (light emitting diode), plasma display or the like. User input may be received from the input devices 1760, e.g., keyboard, mouse, touchpad, microphone, and the like. Each of the foregoing modules and/or devices may even be situated on a single semiconductor platform to form the system 1765. Alternately, the various modules may also be situated separately or in various combinations of semiconductor platforms per the desires of the user.

Further, the system 1765 may be coupled to a network (e.g., a telecommunications network, local area network (LAN), wireless network, wide area network (WAN) such as the Internet, peer-to-peer network, cable network, or the like) through a network interface 1735 for communication purposes.

The system 1765 may also include secondary storage (not shown). Secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory, or the like. The removable storage drive reads from and/or writes to a removable storage medium in a well-known manner.

Computer programs, or computer control logic algorithms, may be stored in the main memory 1740 and/or secondary storage. Such computer programs, when executed, enable the system 1765 to perform various functions. The memory 1740, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1765 may take the form of a desktop computer, a laptop computer, a tablet computer, servers, supercomputers, a smartphone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

An application program may be implemented via an application executed by a host processor, such as a CPU. In an embodiment, a device driver may implement an application programming interface (API) that defines various functions that can be utilized by the application program in order to generate graphical data for display. The device driver is a software program that includes a plurality of instructions that control the operation of the multi-dielet GPU 1600 comprising two or more PPU 1400. The API provides an abstraction for a programmer that lets a programmer utilize specialized graphics hardware, such as the PPU 1400, to generate the graphical data without requiring the programmer to utilize the specific instruction set for the PPU 1400. The application may include an API call that is routed to the device driver for the multi-dielet GPU. The device driver interprets the API call and performs various operations to respond to the API call. In some instances, the device driver may perform operations by executing instructions on the CPU. In other instances, the device driver may perform operations, at least in part, by launching operations on the multi-dielet GPU 1600 utilizing an input/output interface between the CPU and the multi-dielet GPU. In an embodiment, the device driver is configured to implement the graphics processing pipeline utilizing the hardware of the PPU 1400.

Various programs may be executed within the multi-dielet GPU 1600 comprising two or more PPU 1400 in order to implement the various stages of the processing for the application program. For example, the device driver may launch a kernel on the PPU 1400 to perform one stage of processing on one SM 1540 (or multiple SMs 1540). The device driver (or the initial kernel executed by PPU 1400) may also launch other kernels on the PPU 1400 to perform other stages of the processing. If the application program processing includes a graphics processing pipeline, then some of the stages of the graphics processing pipeline may be implemented on fixed unit hardware such as a rasterizer or a data assembler implemented within the PPU 1400. It will be appreciated that results from one kernel may be processed by one or more intervening fixed function hardware units before being processed by a subsequent kernel on an SM 1540.

The techniques disclosed herein may be incorporated in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA Geforce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All publications including but not limited to patent publications cited herein are incorporated herein by reference as if expressly set forth.

While the preceding is directed to embodiments of the present disclosure, other and further embodiments of the disclosure may be devised without departing from the scope thereof, and the scope of protection is therefore determined by combinations of elements and/or features of the claims that follow.

1. In a multi-chip GPU including first rendering hardware disposed on a first die for rendering first pixels into a first frame buffer tile and second rendering hardware disposed on a second die for rendering second pixels into a second frame buffer tile, the first die and the second die communicating via a chip-to-chip communication interface, a method comprising:
(a) the first rendering hardware writing first rendering parameters to first point of coherence memory locally connected to the first die without requiring writes over the chip-to-chip communication interface to the second die, and
(b) the second rendering hardware writing second rendering parameters to second point of coherence memory locally connected to the second die without requiring writes over the chip-to-chip communication interface to the first die, wherein the first rendering hardware and the second rendering hardware are each configured to locally cache portions of the first rendering parameters written to the first point of coherence memory locally connected to the first die and the second rendering parameters written to the second point of coherence memory locally connected to the second die.

2. The method of claim 1, wherein the first point of coherence memory locally connected to the first rendering hardware comprises video memory locally connected to the first rendering hardware, the second point of coherence memory locally connected to the second rendering hardware comprises video memory locally connected to the second rendering hardware, and the first and second rendering parameters comprise primitive vertex attributes.

3. A method performed in a multiple-GPU-based system of the type that uses unified memory addressing to enable multiple GPUs to have a common unified view into memory and access each other's locally connected memory, the method comprising:
on each GPU of the multiple GPUs, mapping a virtual memory address of a set of buffers configured to be written to by processing pipelines on the each GPU to a physical memory address of a part of the locally connected memory of the each GPU,
wherein the virtual memory addresses of the sets of buffers of the multiple GPUs are in contiguous virtual memory in the common unified view and the respective parts of the locally connected memories of the multiple GPUs are interleaved; and
writing, using the mapped virtual memory address of the set of buffers, data output from a stage of a processing pipeline of the GPU to the part of the locally connected memory of the GPU.

4. The method of claim 3, wherein the set of buffers comprises a respective buffer written to by each of a plurality of processing pipelines on the each GPU, and wherein the each processing pipeline is a graphics processing hardware pipeline.

5. The method of claim 4, wherein the respective buffer is an alpha circular buffer or a beta circular buffer that is used for a stage of the each processing pipeline to provide data to another stage of the each processing pipeline.

6. The method of claim 5, wherein the respective buffer is an alpha circular buffer, and wherein the alpha circular buffer is configured to redistribute vertex attributes from one stage of a tessellation pipeline portion of the each processing pipeline to another stage of the tessellation pipeline portion.

7. The method of claim 5, wherein the respective buffer is a beta circular buffer, and wherein the beta circular buffer is configured to redistribute vertex attributes from a world pipe portion of the each processing pipeline to a screen pipe portion of the each processing pipeline.

8. The method of claim 3, wherein the each locally connected memory is a frame buffer memory, and wherein the set of buffers written to by processing pipelines on the each GPU to a part of the locally connected memory of the each GPU is cached in an L2 cache on the each GPU.

9. The method of claim 8, wherein processing in the each processing pipeline includes writing data to the buffer and waiting for acknowledgment of the writing having reached a point of coherence.

10. The method of claim 3, further comprising: when a buffer entry of the plurality of buffers of the GPU is freed, transmitting an invalidate request to other GPUs of the multiple GPUs.

11. The method of claim 10, wherein the invalidate request is transmitted to an L2 cache of the GPU in response to a free buffer/recycle signal received from the processing pipeline of the GPU.

12. The method of claim 3, wherein the on each GPU of the multiple GPUs, mapping a virtual memory address of a set of buffers written to by processing pipelines on the each GPU to a part of the locally connected memory of the each GPU comprises mapping a first address of a first set of buffers to a first part of the locally connected memory and mapping a second address of a second set of buffers to a second part of the locally connected memory.

13. The method of claim 12, wherein the mapping the first address comprises programming a first register with a first offset value and the mapping the second address comprises programming a second register with a second offset value, wherein the first offset value and the second offset value are both specified in relation to a same base address in the locally connected memory of the GPU.

14. The method of claim 1, wherein the multiple-GPU-based system comprises a plurality of GPUs, wherein each of the multiple GPUs is on a respective die.

15. The method of claim 1, wherein respective blocks of a first size in the virtual memory are each divided to a plurality of blocks of a second size and each block of the second size is allocated in a locally connected memory of a respective one of the multiple GPUs.

16. A method performed in a multiple-GPU-based system of the type that uses unified memory addressing to enable multiple GPUs to have a common unified view into memory and access each other's locally connected memory, the method comprising:
on each GPU of the multiple GPUs:
map a local memory base address in virtual memory to a part of the locally connected memory of the each GPU; and
provide each of a plurality of processing cores of the each GPU with a respective local memory offset with respect to the local memory base address.

17. The method of claim 16, wherein the method further comprises, on each GPU of the multiple GPUs, processes on the plurality of processing cores of the each GPU write intermediate data to the area indicated by the corresponding respective local memory offset.

18. A method performed in a multiple-GPU-based system of the type that uses unified memory addressing to enable multiple GPUs to have a common unified view into memory and access each other's locally connected memory, the method comprising:
on one GPU of the multiple GPUs:
map one or more memory base addresses in virtual memory to respective parts of the locally connected memory of the one GPU; and
write constant data, root table version circular buffer data, or page pool circular buffer data, to respective ones of the one or more memory base addresses.

19. The method of claim 18, wherein the write constant data, root table version circular buffer data, or page pool circular buffer data, to respective ones of the one or more memory base addresses comprises writing the root table version circular buffer data or the page pool circular buffer data to respective ones of the one or more memory base addresses.

20. The method of claim 18, wherein the write constant data, root table version circular buffer data, or page pool circular buffer data, to respective ones of the one or more memory base addresses comprises writing the constant data to respective ones of the one or more memory base addresses.

21. The method of claim 18, wherein the constant data, the root table version circular buffer data, or the page pool circular buffer data written to the ones of the one or more memory base addresses is provided to other GPUs of the multiple GPUs.

22. The method of claim 18, further comprising: when a buffer entry of the plurality of buffers of the GPU is freed, transmitting an invalidate request to other GPUs of the multiple GPUs.

23. The method of claim 22, wherein the invalidate request is transmitted by an L2 cache of the GPU in response to a free buffer signal received from the pipeline on the GPU.

24. The method of claim 3, wherein the multiple-GPU-based system enables access by the multiple GPUs of each other's locally connected memory via chip-to-chip network connectivity.
